(19) United States
(12) Patent Application Publication
(10) Pub. No.: US 2025/0199425 A1
(43) Pub. Date: Jun. 19, 2025

(54) TONER

(71) Applicant: CANON KABUSHIKI KAISHA, Tokyo (JP)

(72) Inventors: YUKI MASUDA, Shizuoka (JP); KENTARO YAMAWAKI, Shizuoka (JP); SHUHEI IWASAKI, Kanagawa (JP); KENJI AOKI, Shizuoka (JP)

(21) Appl. No.: 18/971,964

(22) Filed: Dec. 6, 2024

(30) Foreign Application Priority Data
Dec. 13, 2023 (JP) 2023-210474
Nov. 25, 2024 (JP) 2024-204562

(51) Int. Cl. G03G 9/087; C08F 220/12

(52) U.S. Cl. CPC G03G 9/08711; C08F 220/12

(57) ABSTRACT

A toner comprising a toner particle comprising a binder resin and a release agent, wherein the binder resin comprises a crystalline vinyl resin, the crystalline vinyl resin comprises 5.0% by mass or more of a monomer unit (a) represented by a following formula (1), based on a mass of the crystalline vinyl resin,

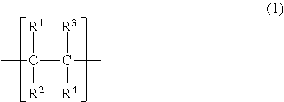

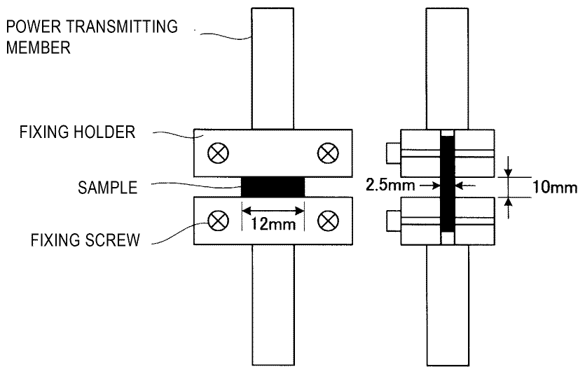

in the formula (1), at least two of R¹ to R⁴ are each independently —X—COOR⁵, and a remaining is each independently a hydrogen atom or an alkyl group having 1 to 4 carbon atoms, X is a single bond or an alkylene group having 1 or 2 carbon atoms, R⁵ is an alkyl group having 16 to 30 carbon atoms, and a peak molecular weight Mp of the release agent is 800 or more.

### BACKGROUND OF THE INVENTION

### Field of the Invention

The present disclosure relates to a toner for use in electrophotography and electrostatic recording.

### Description of the Related Art

Methods, e.g., electrophotography, of visualizing image information by toner are currently used in various fields, and there is a demand for improved performance, including high image quality and energy saving. In the electrophotography method, first, an electrostatic latent image is formed on an electrophotographic photosensitive member (image bearing member) through charging and exposure steps. Next, the electrostatic latent image is developed with a developer containing a toner, and a visualized image (fixed image) is obtained through a transfer step and a fixing step.

Among these steps, the fixing step requires a relatively large amount of energy, and the development of systems and materials that can achieve both energy saving and high image quality is an important technical issue. As an approach from the material side, a technique using a crystalline resin as a binder resin of a toner is being considered. Crystalline resins have excellent heat-resistant storage stability because the molecular chains are regularly arranged, thereby essentially preventing softening at temperatures lower than the melting point. Meanwhile, when the melting point is exceeded, the crystals melt rapidly, which is accompanied by a rapid drop in viscosity. For this reason, crystalline resins are attracting attention as materials that have excellent sharp melt property and exhibit low-temperature fixability.

Known crystalline resins include main-chain crystalline resins, which are represented by crystalline polyesters and in which the main chain crystallizes, and side-chain crystalline resins, which are represented by long-chain alkyl acrylate polymers and in which the side chains crystallize. In particular, side-chain crystalline resins are known to exhibit excellent low-temperature fixability because the degree of crystallization thereof is easy to increase, and such resins have been widely studied. Crystalline vinyl resins are examples of the side-chain crystalline resins. The crystalline vinyl resins have long-chain alkyl groups as side chains, and crystallinity is exhibited as a result of the long-chain alkyl groups being oriented to each other.

As a toner using a crystalline vinyl resin, Japanese Patent Application Publication No. 2020-173414 discloses a toner that uses a crystalline vinyl resin, which is a copolymer of a polymerizable monomer having a long-chain alkyl group and an amorphous polymerizable monomer having a different SP value, and also uses a release agent having a molecular weight of 1000 or more. By controlling the SP value, a structure is obtained in which the polymerizable monomers having long-chain alkyl groups are continuously bonded to a certain extent, hence the crystallinity of the crystalline vinyl resin is easily maintained. In addition, by using a release agent having a molecular weight of 1000 or more in order to reduce the compatibility with the crystalline vinyl resin during fixing, low-temperature fixability, heat-resistant storage stability, durability and release property can be achieved at the same time.

### SUMMARY OF THE INVENTION

The technique of Japanese Patent Application Publication No. 2020-173414 excels in achieving low-temperature fixability, heat-resistant storage stability, durability and release property at the same time.

Furthermore, in recent years, with various usage scenarios expected, there is a demand for faster printing processes to improve productivity when using printers, and in particular, there is a growing demand for faster fixing speeds. In response to this, the research conducted by the inventors has shown that the conventional toners have excellent low-temperature fixability and are therefore also adaptable to processes set at high speeds.

Meanwhile, when adaptability of the toner of Japanese Patent Application Publication No. 2020-173414 to a high-speed fixing process was checked after storage in a high-temperature environment, it was found that the toner was not fixed at the same fixing speed, and the fixing speed required to achieve the same fixing temperature was reduced.

The reason for this is assumed to be as follows. The toner of Japanese Patent Application Publication No. 2020-173414 is characterized in that the crystalline resin contains a (meth)acrylate structure having long-chain alkyl groups as side chains. Such crystalline resins are hard below the melting point. However, some molecular motion may occur at a molecular level. The molecular motion is particularly likely to be activated at high temperatures.

The toner of Japanese Patent Application Publication No. 2020-173414 has excellent heat-resistant storage stability, and aggregation of toner particles during high-temperature storage can be suppressed. However, the molecular motion inside the toner cannot be completely suppressed, and it is believed that some of the crystals undergo changes when the toner is stored in a high-temperature environment. These crystals cause molecular motion and form in the toner a eutectic state with a release agent having a similar crystal structure.

In view of the above, the inventors believe that the reason for the change in fixability after storage in a high-temperature environment compared to that before storage is as follows. The release agent and crystalline vinyl resin in the toner are likely to form a eutectic, and the release agent is captured by the binder resin, which reduces the rate at which the release agent exudes during high-speed fixing.

The present disclosure provides a toner that has excellent low-temperature fixability and hot offset resistance (release property), and furthermore, has a fixing speed that does not change even after storage in a high-temperature environment.

A toner of the present disclosure is a toner comprising a toner particle comprising a binder resin and a release agent, wherein
the binder resin comprises a crystalline vinyl resin,
the crystalline vinyl resin comprises 5.0% by mass or more of a monomer unit (a) represented by a following formula (1), based on a mass of the crystalline vinyl resin,

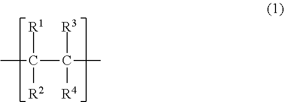

in the formula (1), at least two of R¹ to R⁴ are each independently —X—COOR⁵, and a remaining is each independently a hydrogen atom or an alkyl group having 1 to 4 carbon atoms, X is a single bond or an alkylene group having 1 or 2 carbon atoms, R⁵ is an alkyl group having 16 to 30 carbon atoms, and
a peak molecular weight Mp of the release agent is 800 or more.

According to the present disclosure, a toner can be provided that has excellent low-temperature fixability and hot offset resistance, and furthermore, has a fixing speed that does not change even after storage in a high-temperature environment. Further features of the present invention will become apparent from the following description of exemplary embodiments with reference to the attached drawing.

### BRIEF DESCRIPTION OF THE DRAWING

The FIGURE is an example of sample attachment for viscoelasticity measurement.

### DESCRIPTION OF THE EMBODIMENTS

In the present disclosure the notations “from XX to YY” and “XX to YY” representing a numerical value range signify, unless otherwise specified, a numerical value range that includes the lower limit and the upper limit of the range, as endpoints. In a case where numerical value ranges are described in stages, the upper limits and the lower limits of the respective numerical value ranges can be combined arbitrarily. In the present disclosure, for instance, a wording such as “at least one selected from the group consisting of XX, YY and ZZ” encompasses XX, YY and ZZ, a combination of XX and YY, a combination of XX and ZZ, a combination of YY and ZZ, and a combination of XX, YY and ZZ.

(Meth)acrylic acid ester means acrylic acid ester and/or methacrylic acid ester.

“Monomer unit” refers to the reacted form of a monomer substance in a polymer. For example, one section defined by carbon-carbon bonds in the main chain of a polymer obtained by polymerization of polymerizable monomers is considered to be one unit. A polymerizable monomer can be represented by the following formula (C).

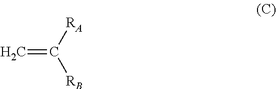

[In formula (C), R_{A} represents a hydrogen atom or an alkyl group (preferably an alkyl group having 1 to 3 carbon atoms, more preferably a methyl group), and R_{B} represents a freely selected substituent].

Crystalline resin refers to a resin that shows a clear endothermic peak in differential scanning calorimetry (DSC) measurements.

### Features of the Present Disclosure

The inventors conducted extensive research to solve the above problems and have found that by combining a crystalline vinyl resin having a specific monomer unit as a binder resin that constitutes the toner particle, and a release agent having a peak molecular weight Mp of 800 or more, it is possible to provide a toner that has excellent low-temperature fixability and hot offset resistance, and further, the fixing speed of the toner does not change even after storage in a high-temperature environment, thereby allowing fixing at a high fixing speed.

That is, the toner of the present disclosure comprises a toner particle comprising a binder resin and a release agent. The binder resin comprises a crystalline vinyl resin. The crystalline vinyl resin comprises 5.0% by mass or more of a monomer unit (a) represented by the following formula (1), based on the mass of the crystalline vinyl resin.

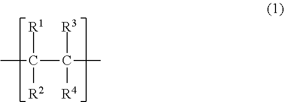

In formula (1), at least two of R¹ to R⁴ are each independently —X—COOR⁵, and the remaining is each independently a hydrogen atom or an alkyl group having 1 to 4 carbon atoms, X is a single bond or an alkylene group having 1 or 2 carbon atoms, and R⁵ is an alkyl group having 16 to 30 carbon atoms. The peak molecular weight Mp of the release agent is 800 or more.

The inventors believe that the above problem can be solved with such a configuration according to the following mechanism. As described above, in the conventional toner, the crystalline resin constituting the binder resin contains a (meth)acrylate structure having a long-chain alkyl group as a side chain. In this case, by storing the toner in a high-temperature environment, a eutectic is easily formed between the crystalline resin and the release agent. Although the binder resin contained in the toner particle is hard below the melting point or the glass transition point, it is not completely immobilized at the molecular level, and molecular motion can occur. This molecular motion becomes more active as the temperature increases.

According to the research conducted by the inventors, when the toner is stored in a high-temperature environment, molecular chain motion occurs in both the crystalline resin and the release agent, making it easier to form a eutectic in which the two are in a stable state. As a result, the release agent is captured by the binder resin, which is believed to be a reason why the exudation of the release agent is insufficient during high-speed fixing.

In contrast, the toner of the present disclosure has the above configuration.

As described later, using a release agent with a high peak molecular weight reduces the compatibility between the crystalline vinyl resin and the release agent during fixing, thereby ensuring excellent hot offset resistance.

Meanwhile, crystalline vinyl resins exhibit excellent low-temperature fixability that is unique to crystalline resins. Furthermore, when the crystalline vinyl resin contains a predetermined amount of the monomer unit (a) represented by the above formula (1), the long-chain alkyl groups that contribute to the expression of crystallinity are located close to each other. This is believed to increase the crystal density, reduce the degree of freedom of the molecules, and reduce the mobility of the molecules.

Therefore, it is believed that even in toners exposed to high-temperature environments, the crystalline vinyl resin and the release agent with a high peak molecular weight are prevented from unintentionally forming a eutectic, and the release agent and the binder resin are maintained in a phase-separated state. In such toners with few eutectic structures, the release agent is present in a phase-separated state from the binder resin during fixing, and quickly exudes onto the toner surface when melted. It is believed that this is why the release property is maintained even at high fixing speeds.

Thus, no attempt has been heretofore made to maintain fixability in a high-speed fixing system even after storage in a high-temperature environment by controlling the crystal density by the distance between the linear alkyl groups that are side chains.

It is believed that due to the above mechanism, it is possible to provide a toner of the present disclosure that has excellent low-temperature fixability and hot offset resistance, and furthermore, has the fixing speed does not change even after storage in a high-temperature environment.

The toner will be described in detail hereinbelow. The toner comprises a toner particle. The toner particle may be used as a toner as is or may be used as a toner by mixing with an external additive or the like to attach the external additive to the surface of the toner particle as necessary.

### Toner Particle

The toner particle will be described hereinbelow. The toner particle comprises a binder resin and a release agent. The toner particle may contain a colorant, a charge control agent, and the like in addition to the binder resin.

### Binder Resin

The binder resin comprises a crystalline vinyl resin, and the crystalline vinyl resin comprises 5.0% by mass or more of the monomer unit (a) represented by the above formula (1) based on the mass of the crystalline vinyl resin. In other words, the content ratio of the monomer unit (a) is 5.0% by mass or more based on the mass of the crystalline vinyl resin. Where the content ratio of the monomer unit (a) represented by the above formula (1) based on the mass of the crystalline vinyl resin (hereinafter also referred to as ratio J) is less than 5.0% by mass, a high fixing speed cannot be maintained after storage in a high-temperature environment.

From the viewpoint of reducing the change in fixing speed in a high-speed fixing system even after storage in a high-temperature environment, the ratio J is preferably 30.0% by mass or more, and more preferably 45.0% by mass or more. For example, the ratio J is preferably 5.0% by mass to 100.0% by mass, more preferably 5.0% by mass to 90.0% by mass, even more preferably 30.0% by mass to 90.0% by mass, and particularly preferably 45.0% by mass to 85.0% by mass.

Furthermore, from the viewpoint of reducing the change in fixing speed in a high-speed fixing system even after storage in a high-temperature environment, the ratio J is preferably 0.7 mol % or more. For example, the ratio J is preferably 0.7 mol % to 40.0 mol %, more preferably 4.0 mol % to 40.0 mol %, and even more preferably 20.0 mol % to 35.0 mol % in terms of molar ratio. A method for introducing the monomer unit (a) into the crystalline vinyl resin will be described hereinbelow. The ratio J can be controlled by the amount of raw materials charged when synthesizing the crystalline vinyl resin.

The crystalline vinyl resin comprises the monomer unit (a) represented by the above formula (1). In formula (1), at least two of R¹ to R⁴ are each independently —X—COOR⁵ (X is a single bond or an alkylene group having 1 or 2 carbon atoms, and R⁵ is an alkyl group having 16 to 30 carbon atoms), and the remaining is each independently hydrogen or an alkyl group having 1 to 4 carbon atoms (preferably 1 or 2).

When such a structure is satisfied, it is possible to obtain excellent low-temperature fixability and hot offset resistance, and to reduce the change in fixing speed in a high-speed fixing system even after storage in a high-temperature environment.

When one of R¹ to R⁴ satisfies —X—COOR⁵ and the remaining is each independently hydrogen or an alkyl group having 1 to 4 carbon atoms, a high fixing speed may not be maintained in a high-speed fixing system after storage in a high-temperature environment.

As a preferred structure of the substituents, it is preferable that two of R¹ to R⁴ (more preferably one of R¹ and R², and one of R³ and R⁴) are each independently —X—COOR⁵ (X is a single bond or an alkylene group having 1 or 2 carbon atoms, and R⁵ is an alkyl group having 16 to 30 carbon atoms), and the remaining are each independently hydrogen or an alkyl group having 1 to 4 carbon atoms. Furthermore, it is more preferable that two of R¹ to R⁴ (more preferably, one of R¹ and R², and one of R³ and R⁴) are each independently —X—COOR⁵ (X is a single bond or an alkylene group having 1 or 2 carbon atoms, R⁵ is an alkyl group having 16 to 30 carbon atoms), and the remaining are hydrogen atoms or methyl groups. X is also preferably a single bond.

R⁵ is an alkyl group having 16 to 30 carbon atoms. When R⁵ is an alkyl group having 16 to 30 carbon atoms, the crystalline vinyl resin is more likely to express crystallinity, and a toner having excellent low-temperature fixability can be obtained. In addition, a high fixing speed can be maintained after storage in a high-temperature environment. When R⁵ has less than 16 carbon atoms, the fixing speed is likely to decrease after storage in a high-temperature environment, and when R⁵ has more than 30 carbon atoms, the low-temperature fixability is likely to decrease. R⁵ is preferably an alkyl group having 18 to 28 carbon atoms, and more preferably an alkyl group having 20 to 24 carbon atoms. The alkyl group of R⁵ is preferably linear.

The binder resin preferably comprises 20.0% by mass or more of crystalline vinyl resin based on the mass of the binder resin (the content ratio of crystalline vinyl resin based on the mass of the binder resin is hereinafter also referred to as ratio I). When the ratio I is 20% by mass or more, it becomes easier to achieve both low-temperature fixability and the effect of maintaining a high fixing speed even after storage in a high-temperature environment. The upper limit of ratio I is not particularly limited but is preferably 20.0% by mass to 100.0% by mass, more preferably 20.0% by mass to 70.0% by mass, and even more preferably 40.0% by mass to 60.0% by mass. The ratio I can be controlled by the amount of crystalline vinyl resin charged during the production of toner particles and the amount of other materials charged.

In addition, the crystalline vinyl resin may or may not contain a monomer unit having an alkyl group having 16 to 30 carbon atoms that is different from the monomer unit (a) in addition to the monomer unit (a). In the crystalline vinyl resin, the content ratio (hereinafter also referred to as ratio K) of monomer unit (a) among monomer units which have an alkyl group having 16 to 30 carbon atoms, and include the monomer unit (a), is preferably from 50.0% by mass to 100% by mass, more preferably from 75.0% by mass to 100.0% by mass, and even more preferably from 90.0% by mass to 100.0% by mass.

The fact that the ratio K is in the above range indicates that there are many segments with high density of side chains. Therefore, the movement of resin molecules is restricted and eutectic is unlikely to be formed. As a result, it is possible to reduce the change in fixing speed in a high-speed fixing system even after storage in a high-temperature environment.

A method for introducing the monomer unit (a) represented by formula (1) in the crystalline vinyl resin involves using a polymerizable ester, which is a condensation product of a polyvalent carboxylic acid having 4 to 6 carbon atoms and a carbon-carbon double bond with a monoalcohol having 16 to 30 carbon atoms and a chain-like hydrocarbon group, as a polymerizable monomer. The monomer unit (a) represented by formula (1) may be used alone or in combination of two or more types.

Examples of polyvalent carboxylic acids having 4 to 6 carbon atoms and a carbon-carbon double bond include maleic acid, fumaric acid, citraconic acid, mesaconic acid, itaconic acid, glutaconic acid, trans-aconitic acid, and cis-aconitic acid. Acid anhydrides and lower alkyl (1 to 4 carbon atoms) esters (for example, methyl ester, ethyl ester, isopropyl ester, and the like) of these polyvalent carboxylic acids may also be used. The polyvalent carboxylic acids may be used alone or in combination of two or more types. Among these, at least one selected from the group consisting of maleic acid, fumaric acid, itaconic acid, and acid anhydrides thereof is preferred. More preferred is at least one selected from the group consisting of maleic acid, fumaric acid, and acid anhydrides thereof.

Examples of monoalcohols having 16 to 30 carbon atoms and a chain-like hydrocarbon group include alcohols having a linear alkyl group (alkyl group having 16 to 30 carbon atoms) (cetanol, stearyl alcohol, 1-eicosanol, behenyl alcohol, 1-tetracosanol, 1-triacontanol, and the like) and alcohols having a branched alkyl group (alkyl group having 16 to 30 carbon atoms) (2-decyl-1-tetradecanol and the like). Of these, from the viewpoint of crystallinity, alcohols having a linear alkyl group (alkyl group having 16 to 30 carbon atoms) are preferred. Alcohols having a linear alkyl group (alkyl group having 18 to 28 carbon atoms) are more preferred, and alcohols having a linear alkyl group (alkyl group having 20 to 24 carbon atoms) are even more preferred.

A method for producing the polymerizable ester is not particularly limited, provided that a polyvalent carboxylic acid having 4 to 6 carbon atoms and a carbon-carbon double bond is condensed with a monoalcohol having 16 to 30 carbon atoms and a chain-like hydrocarbon group. It is preferable to use an esterification catalyst or a stabilizer (polymerization inhibitor) to ensure that the condensation reaction proceeds reliably and the reaction of the carbon-carbon double bonds during the production of the polymerizable ester is prevented.

The acid value of the crystalline vinyl resin is preferably 3.0 mg KOH/g or less from the viewpoint of further improving low-temperature fixability and from the viewpoint of reducing the change in fixing speed in a high-speed fixing system even after storage in a high-temperature environment. The acid value of the crystalline vinyl resin is preferably 0.0 mg KOH/g to 3.0 mg KOH/g, more preferably 0.0 mg KOH/g to 1.0 mg KOH/g, and even more preferably 0.2 mg KOH/g to 1.0 mg KOH/g. An acid value of 3.0 mg KOH/g or less indicates that there are few unreacted segments when synthesizing the crystalline vinyl resin. Therefore, it is believed that the crystallinity is favorably expressed and the crystal density is high. In order to control the acid value within the above ranges, a method of changing the ratio of carboxylic acid and alcohol when synthesizing the crystalline vinyl resin can be exemplified.

The crystalline vinyl resin may contain other monomer units in addition to the monomer unit (a) represented by formula (1). The crystalline vinyl resin may contain a plurality of other monomer units. A method for polymerizing the above polymerizable ester with other vinyl monomers can be used for introducing the other monomer units. The crystalline vinyl resin is preferably a polymer of the above polymerizable ester with other vinyl monomers.

The other vinyl monomers include the following.

Styrene, α-methylstyrene, and (meth)acrylic acid esters such as methyl (meth)acrylate, ethyl (meth)acrylate, n-butyl (meth)acrylate, t-butyl (meth)acrylate, and 2-ethylhexyl (meth)acrylate.

Monomers having a urea group: for example, monomers obtained by reacting an amine having 3 to 22 carbon atoms [primary amines (such as normal butylamine, t-butylamine, propylamine, and isopropylamine), secondary amines (such as di-normal ethylamine, di-normal propylamine, and di-normal butylamine), aniline, and cycloxylamine] with an isocyanate having 2 to 30 carbon atoms and an ethylenically unsaturated bond, using a known method.

Monomers having a carboxy group: for example, methacrylic acid, acrylic acid, 2-carboxyethyl (meth)acrylate, and the like.

Monomers having a hydroxy group: for example, 2-hydroxyethyl (meth)acrylate, 2-hydroxypropyl (meth)acrylate, and the like.

Monomers having an amide group: for example, acrylamide, and monomers obtained by reacting an amine having 1 to 30 carbon atoms with a carboxylic acid having 2 to 30 carbon atoms and an ethylenically unsaturated bond (such as acrylic acid and methacrylic acid), using a known method.

Monomers having a lactam structure; for example, N-vinyl-2-pyrrolidone.

Among these, it is preferred that the crystalline vinyl resin comprises, in addition to the monomer unit (a), a monomer unit (b) different from the monomer unit (a). Where the SP value of the monomer unit (a) is SPa (J/cm³)^{0.5} and the SP value of the monomer unit (b) is SPb (J/cm³)^{0.5}, it is preferred that SPa and SPb satisfy the following formula (3). However, when there are two or more types of other monomer units used in addition to the monomer unit (a) represented by formula (1), a monomer unit that has the largest difference in SP value from the monomer unit (a) is selected as the monomer unit (b).

$$3. \leq \vert SPb - SPa \vert \leq 21. \qquad ( 3 )$$

When the relationship between the SP value SPa of the monomer unit (a) and the SP value SPb of the monomer unit (b) is within the above range, the crystalline segments and amorphous segments in the crystalline vinyl resin tend to form a clear phase separation state. Therefore, the crystallinity does not decrease, and low-temperature fixability is easily improved. The value of |SPb−SPa| can be controlled by the type and amount of polymerizable monomer added when preparing the crystalline vinyl resin.

Furthermore, it is more preferable that the relationship between SPa and SPb satisfy the following formula (3-1).

$$7. \leq \vert SPb - SPa \vert \leq 12. \qquad ( 3 - 1 )$$

The crystalline vinyl resin preferably contains a monomer unit corresponding to methacrylonitrile. The crystalline vinyl resin preferably contains 1.0% by mass to 25.0% by mass and more preferably 10.0% by mass to 20.0% by mass of a monomer unit corresponding to methacrylonitrile.

The crystalline vinyl resin also preferably contains a monomer unit corresponding to styrene. The crystalline vinyl resin preferably contains 1.0% by mass to 81.0% by mass, more preferably 1.0% by mass to 60.0% by mass, and even more preferably 4.0% by mass to 10.0% by mass of a monomer unit corresponding to styrene.

The crystalline vinyl resin may be produced by any conventionally known method within the scope of the present configuration, but is preferably produced by polymerizing a composition of a polymerizable monomer containing the above-mentioned polymerizable ester with an initiator or the like.

### Release Agent

The toner comprises a release agent with a peak molecular weight Mp of 800 or more. When the peak molecular weight is 800 or more, the compatibility with the crystalline vinyl resin during fixing decreases. As a result, the release agent exudes onto the toner surface during fixing, thereby improving hot offset resistance. Where the peak molecular weight of the release agent is less than 800, the release agent becomes more compatible with the crystalline vinyl resin in the toner during fixing, and is less likely to exude, resulting in a decrease in hot offset resistance.

The peak molecular weight (Mp) of the release agent herein refers to the peak molecular weight measured by gel permeation chromatography (GPC). The measurement method will be described hereinbelow.

The release agent is not particularly limited as long as the peak molecular weight Mp is 800 or more. The release agent preferably comprises at least one selected from the group consisting of ester waxes and hydrocarbon waxes, and more preferably comprises an ester wax. The release agent is preferably at least one selected from the group consisting of ester waxes and hydrocarbon waxes, and more preferably is an ester wax.

As a result of the release agent containing an ester wax, the release agent portions in the toner are present in a state where they are combined together. As a result, eutectic with the crystalline vinyl resin is less likely to be formed after storage in a high-temperature environment, and it is easier to reduce changes in the fixing speed in a high-speed fixing system even after storage in a high-temperature environment.

The ester wax may be either a natural ester wax or a synthetic ester wax, as long as it has at least one ester bond in one molecule.

There are no particular limitations on the ester wax, but examples thereof include the following:
esters of monohydric alcohols and monocarboxylic acids such as behenyl behenate, stearyl stearate, and palmityl palmitate;
esters of divalent carboxylic acids and monohydric alcohols such as dibehenyl sebacate;
esters of dihydric alcohols and monocarboxylic acids such as ethylene glycol distearate and hexanediol dibehenate;
esters of trihydric alcohols and monocarboxylic acids such as glycerin tribehenate;
esters of tetrahydric alcohols and monocarboxylic acids such as pentaerythritol tetrastearate and pentaerythritol tetrapalmitate;
esters of hexahydric alcohols and monocarboxylic acids such as dipentaerythritol hexastearate, dipentaerythritol hexapalmitate, and dipentaerythritol hexabehenate;
esters of polyfunctional alcohols and monocarboxylic acids such as polyglycerin behenate; and
natural ester waxes such as carnauba wax and rice wax.

Among these, it is preferable that the release agent comprises an ester wax that is an ester of a tetrahydric to octahydric alcohol and an aliphatic monocarboxylic acid, or an ester wax that is an ester of a tetravalent to octavalent carboxylic acid and an aliphatic monoalcohol. It is also more preferable that the release agent be an ester wax that is an ester of a tetrahydric to octahydric alcohol and an aliphatic monocarboxylic acid, or an ester wax that is an ester of a tetravalent to octavalent carboxylic acid and an aliphatic monoalcohol. When such an ester wax is contained, in addition to the effects of the ester wax, the molecular weight is easy to control and compatibility with the crystalline vinyl resin during fixing is reduced, so that the hot offset resistance is easy to increase.

More preferred are esters of hexahydric alcohols and monocarboxylic acids, such as dipentaerythritol hexastearate, dipentaerythritol hexapalmitate, and dipentaerythritol hexabehenate, and esters of octahydric alcohols and monocarboxylic acids, such as tripentaerythritol octastearate, tripentaerythritol octapalmitate, and tripentaerythritol octabehenate.

There are no particular limitations on the hydrocarbon wax, but it is preferable that the release agent contain, for example, an aliphatic hydrocarbon wax. It is also more preferable that the release agent be an aliphatic hydrocarbon wax.

When the release agent contains an aliphatic hydrocarbon wax, it is easy to create a difference in polarity with the crystalline vinyl resin, which reduces the compatibility with the crystalline vinyl resin during fixing and makes it easy to improve hot offset resistance. Examples of aliphatic hydrocarbon waxes include the following.

Low-molecular-weight polyethylene, low-molecular-weight polypropylene, low-molecular-weight olefin copolymers, Fischer-Tropsch waxes, poly-α-olefin waxes, or waxes obtained by oxidizing or adding an acid to these.

For the same reasons, it is more preferable that the aliphatic hydrocarbon wax have a monomer unit represented by the following formula (15) and corresponding to poly-α-olefin. By having the monomer unit represented by the following formula (15), in addition to the effects of the aliphatic hydrocarbon wax, the release agent has high crystallinity and the release agent portions in the toner are present in a state where they are combined together. As a result, eutectic with the crystalline vinyl resin is less likely to be formed after storage in a high-temperature environment, and it is easier to reduce changes in the fixing speed in a high-speed fixing system even after storage in a high-temperature environment.

As an aliphatic hydrocarbon wax having a monomer unit represented by the following formula (15), a copolymer of an alkene having 16 to 37 carbon atoms can be mentioned. Although there is no particular limitation for the alkene having 16 to 37 carbon atoms, 1-triacontene is preferable.

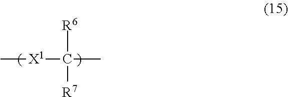

[In formula (15), R⁶ represents a hydrogen atom or a methyl group, R⁷ represents a linear alkyl group having 14 to 34 (preferably 20 to 32, more preferably 25 to 30) carbon atoms, and X¹ represents a methylene group.]

The peak molecular weight of the release agent is preferably 1000 to 5000, and more preferably 1200 to 4600. Where the peak molecular weight is 1000 or more, the crystalline vinyl resin and the release agent are less likely to be compatible with each other during fixing, and hot offset resistance is more likely to be improved. Where the peak molecular weight is 5000 or less, the molecular mobility is high, the release agent is more likely to exude more quickly during fixing after storage in a high-temperature environment, and the fixing speed after storage in a high-temperature environment is more likely to be increased. The peak molecular weight of the release agent can be adjusted by the type of release agent. The method for measuring the peak molecular weight of the release agent will be described hereinbelow.

In a molecular weight distribution of o-dichlorobenzene soluble matter of the release agent measured by gel permeation chromatography, in a differential molecular weight distribution curve obtained by RI detection in which the horizontal axis represents log M, which is the logarithm of the molecular weight, and the vertical axis represents a value [dW/d(log M)] obtained by differentiating a concentration fraction by the logarithm of the molecular weight, a ratio (hereinafter also referred to as ratio H) of an area of a peak in a region of molecular weights of 700 to 1,000,000 to the total area of peaks in a region of molecular weights of 1,000,000 or less is preferably 90.0% or more. Where the ratio H is 90% or more, the crystalline vinyl resin and the release agent are less likely to become compatible with each other, making it easier to improve hot offset resistance.

It is more preferable that the ratio H be 95.0% or more, and even more preferable 98.0% or more. The upper limit is not particularly limited, and for example, it is preferably 90.0% to 100.0%, 95.0% to 100.0%, or 98.0% to 100.0%. The ratio H can be adjusted by the type of release agent. The method for measuring the ratio H will be described hereinbelow.

The content ratio of the release agent (hereinafter also referred to as ratio L) is preferably 2.0% by mass to 80.0% by mass based on the mass of the crystalline vinyl resin. Where the ratio L is 2.0% by mass or more, the release action of the release agent becomes sufficient, and hot offset resistance is easily improved. Where the ratio is 80.0% by mass or less, a eutectic of the release agent and the crystalline vinyl resin is unlikely to be formed during storage in a high-temperature environment, and the fixing speed after storage in a high-temperature environment is easily improved. The ratio L is preferably 5.0% by mass to 75.0% by mass, and more preferably 10.0% by mass to 65.0% by mass.

The release agent preferably has a melting point of 60° C. to 120° C. When the melting point of the release agent is in the above range, the release agent is more likely to melt and exude onto the toner surface during fixing, making it easier to exhibit releasability. The melting point is more preferably 70° C. to 100° C. Where the melting point is lower than 60° C., a eutectic of the release agent and the crystalline vinyl resin is more likely to be formed during storage in a high-temperature environment, making it difficult to improve the fixing speed after storage in a high-temperature environment. Meanwhile, where the melting point is higher than 120° C., the release agent is unlikely to melt appropriately during fixing, and the low-temperature fixability and offset resistance are likely to decrease.

Where the SP value of the crystalline vinyl resin is SP(A) (J/cm³)^{0.5} and the SP value of the release agent is SP(W) (J/cm³)^{0.5}, it is preferable that SP(A) and SP(W) satisfy the following formula (2).

$$( SP ( A ) - SP ( W ) ) \geq 0.4 \qquad ( 2 )$$

Where SP(A) and SP(W) satisfy formula (2), phases of the crystalline vinyl resin and release agent are more likely to separate in the toner. In addition, the release agent has a lower polarity than the crystalline vinyl resin. As a result, the release agent is more likely to effectively exude onto the toner surface during fixing, and the hot offset resistance is likely to be improved. The upper limit of the value of SP(A)−SP(W) is not particularly limited, and for example, the value of SP(A)−SP(W) is 0.4 to 3.0 and 0.8 to 2.4.

SP(A) and SP(W) can be controlled by the type and amount added of polymerizable monomers used when preparing the crystalline vinyl resin and release agent. The calculation method for SP(A) and SP(W) will be described hereinbelow.

Where the temperature at which a storage elastic modulus G^{′} of the toner in viscoelasticity measurement of the toner is 1.0×10⁷ Pa is T1 (° C.), T1 satisfies the following formula (4):

$$50. \leq T 1 \leq 70.0 \qquad ( 4 )$$

Where T1 is 50.0° C. or higher, it is easier to improve the fixing speed after storage in a high-temperature environment. Meanwhile, where T1 is 70.0° C. or lower, the low-temperature fixability is likely to improve. It is also more preferable that T1 satisfy the following formula (4-1).

$$50. \leq T 1 \leq 65. \qquad ( 4 - 1 )$$

T1 can be controlled by the length of the long-chain alkyl group of the crystalline vinyl resin, the proportion of the long-chain alkyl groups in the binder resin, and the like.

In addition, where the ratio of a loss elastic modulus G″ to the storage elastic modulus G^{′} of the toner at the T1 (° C.) in viscoelasticity measurement of the toner is tan δ (T1), and the ratio of the loss elastic modulus G″ to the storage elastic modulus G′ of the toner at a temperature of T1−10 (° C.) is tan δ (T1−10), tan δ (T1) and tan δ (T1−10) satisfy following formulas (5) and (6):

$$0.3 \leq tan δ ( T 1 ) \leq 1. \qquad ( 5 )$$

$$1. \leq tan δ ( T 1 ) / tan δ ( T 1 - 10 ) \leq 1.9 \qquad ( 6 )$$

T1 is the temperature when the toner is melting. Here, tan δ represents the ratio of the loss elastic modulus G″ of the toner to the storage elastic modulus G′. For example, it represents the ease of deformation of the toner, such as whether the toner exhibits strong elastic properties or strong viscous properties. Therefore, by having tan δ (T1) satisfy formula (5), the ease of deformation during low-temperature fixing is maintained at an appropriate level, and a high gloss on rough paper can be easily maintained even when the transfer material is rough paper with a coarse texture.

It is more preferable that the lower limit of tan δ (T1) be 0.40 or more. It is even more preferable that the upper limit of tan δ (T1) be 0.90 or less, and it is still more preferable that the upper limit of tan δ (T1) be 0.80 or less. Thus, in a preferable embodiment, tan δ (T1) satisfies the following formula (5-1), (5-2) or (5-3).

$$0.4 \leq tan δ ( T 1 ) \leq 1. \qquad ( 5 - 1 )$$

$$0.4 \leq tan δ ( T 1 ) \leq 0.9 \qquad ( 5 - 2 )$$

$$0.4 \leq tan δ ( T 1 ) \leq 0.8 \qquad ( 5 - 3 )$$

Here, tan δ (T1) can be controlled by the amount of resin added to the toner, and the like. Also, it can be controlled by the length of the long-chain alkyl group of the crystalline vinyl resin, the proportion of the long-chain alkyl groups in the binder resin, and the like. Furthermore, it can also be controlled by the type and amount added of the crosslinking agent during toner production. The method for measuring tan δ (T1) is described hereinbelow.

Furthermore, tan δ (T1)/tan δ (T1-10) being within the range of formula (6) indicates that the ease of toner deformation during fixing is within a certain range, and the toner can deform gently. As a result, the ease of deformation at the protruded portions and depressed portions of rough paper is within a certain range, and gloss uniformity is likely to be improved.

The lower limit of tan δ (T1)/tan δ (T1-10) is more preferably 1.10 or more, and even more preferably 1.20 or more. The upper limit is more preferably 1.80 or less. In other words, in a preferable embodiment, tan δ (T1) and tan δ (T1-10) satisfy the following formula (6-1), (6-2) or (6-3).

$$1.1 \leq tan δ ( T 1 ) / tan δ ( T 1 - 10 ) \leq 1.9 \qquad ( 6 - 1 )$$

$$1.2 \leq tan δ ( T 1 ) / tan δ ( T 1 - 10 ) \leq 1.9 \qquad ( 6 - 2 )$$

$$1.2 \leq tan δ ( T 1 ) / tan δ ( T 1 - 10 ) \leq 1.8 \qquad ( 6 - 3 )$$

Here, tan δ (T1)/tan δ (T1-10) can be controlled by the type and amount added of polymerizable monomers used in the toner. The method for measuring tan δ (T1-10) will be described hereinbelow.

### Amorphous Resin

The binder resin may contain an amorphous resin. There is no particular limitation on the amorphous resin, but an amorphous vinyl resin is preferred. Vinyl monomers that can be used in the above-mentioned crystalline vinyl resin can be used in the amorphous vinyl resin.

Among them, the amorphous resin preferably contains a monomer unit corresponding to styrene. It is also preferred to include a monomer unit corresponding to a (meth)acrylic acid ester. The monomer unit may be used alone or in combination of two or more types. It is more preferred to include both a monomer unit corresponding to styrene and a monomer unit corresponding to a (meth)acrylic acid ester. In other words, it is more preferred that the amorphous vinyl resin be a polymer of a monomer mixture containing styrene and a (meth)acrylic acid ester.

The amorphous vinyl resin preferably does not contain the monomer unit (a) represented by formula (1).

The content of the amorphous vinyl resin is preferably 10.0% by mass to 90.0% by mass, and more preferably 10.0% by mass to 80.0% by mass based on the mass of the binder resin.

### Colorant

The toner may contain a colorant. Examples of colorants include known organic pigments, organic dyes, inorganic pigments, carbon black as a black colorant, magnetic particles, and the like.

Examples of yellow colorants include the following: condensed azo compounds, isoindolinone compounds, anthraquinone compounds, azo metal complexes, methine compounds, and allylamide compounds. Specifically, C. I. Pigment Yellow 12, 13, 14, 15, 17, 62, 74, 83, 93, 94, 95, 109, 110, 111, 128, 129, 147, 155, 168, and 180 are preferably used.

Examples of magenta colorants include the following: condensed azo compounds, diketopyrrolopyrrole compounds, anthraquinone compounds, quinacridone compounds, basic dye lake compounds, naphthol compounds, benzimidazolone compounds, thioindigo compounds, and perylene compounds. Specifically, C. I. Pigment Red 2, 3, 5, 6, 7, 23, 48:2, 48:3, 48:4, 57:1, 81:1, 122, 144, 146, 166, 169, 177, 184, 185, 202, 206, 220, 221, and 254 are preferably used.

Cyan colorants include the following: copper phthalocyanine compounds and derivatives thereof, anthraquinone compounds, and basic dye lake compounds. Specifically, C. I. Pigment Blue 1, 7, 15, 15:1, 15:2, 15:3, 15:4, 60, 62, and 66 are preferably used.

Colorants are selected in terms of hue angle, chroma, lightness, lightfastness, and dispersibility in the toner.

The content of the colorant is preferably from 1.0 part by mass to 20.0 parts by mass per 100.0 parts by mass of the binder resin. When magnetic particles are used as the colorant, the content thereof is preferably from 40.0 parts by mass to 150.0 parts by mass per 100.0 parts by mass of the binder resin.

### Charge Control Agent

The toner particle may contain a charge control agent as necessary. In addition, the charge control agent may be added externally to the toner particle. By blending the charge control agent, the charge characteristics can be stabilized, and it becomes possible to control the optimal triboelectric charge quantity according to the development system.

As the charge control agent, a known one can be used, and a charge control agent that has a particularly fast charging speed and can stably maintain a constant amount of charge is preferable.

As charge control agents that control the toner to be negatively charged, the following can be mentioned.

Organometallic compounds and chelate compounds are effective, and examples thereof include monoazo metallic compounds, acetylacetone metallic compounds, aromatic hydroxycarboxylic acids, aromatic dicarboxylic acids, and metallic compounds of hydroxycarboxylic acids and dicarboxylic acids.

Examples of compounds that control the toner to be positively charged include the following.

Nigrosine, quaternary ammonium salts, metallic salts of higher fatty acids, diorganotinborates, guanidine compounds, and imidazole compounds.

The content of the charge control agent is preferably from 0.01 parts by mass to 20.0 parts by mass, and more preferably from 0.5 parts by mass to 10.0 parts by mass per 100.0 parts by mass of the toner particle.

### External Additive

The toner particle may be used as it is as a toner or may be made into a toner by mixing with an external additive and the like, as necessary, and attaching the external additive to the toner particle surface.

Examples of external additives include inorganic fine particles selected from the group consisting of silica fine particles, alumina fine particles, and titania fine particles, or composite oxides thereof. Examples of the composite oxides include silica aluminum fine particles and strontium titanate fine particles.

The content of the external additive is preferably from 0.01 parts by mass to 8.0 parts by mass, and more preferably from 0.1 parts by mass to 4.0 parts by mass per 100 parts by mass of the toner particle.

### Method for Producing Toner

A method for producing the toner particle is not particularly limited. The toner particle may be produced by any known method, such as suspension polymerization, emulsion aggregation, dissolution suspension, or pulverization, but the toner particle is preferably produced by suspension polymerization. The toner particle is preferably a suspension-polymerized toner particle. The suspension polymerization method will be described hereinbelow in detail.

For example, a crystalline vinyl resin synthesized in advance is added, together with a release agent, to a mixture of polymerizable monomers that will generate an amorphous resin. If necessary, other materials such as a colorant and a charge control agent are added and uniformly dissolved or dispersed to prepare a polymerizable monomer composition.

The polymerizable monomer composition is then dispersed in an aqueous medium using a stirrer or the like to prepare suspended particles of the polymerizable monomer composition. The polymerizable monomers contained in the particles are then polymerized using an initiator or the like to obtain toner particles.

The toner particles may be filtered, washed, and dried by known methods. Furthermore, an external additive may be added as necessary to obtain a toner.

A known polymerization initiator may be used as the polymerization initiator. Examples thereof include azo or diazo polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide polymerization initiators such as benzoyl peroxide, t-butyl peroxy 2-ethylhexanoate, t-butyl peroxypivalate, t-butyl peroxyisobutyrate, t-butyl peroxyneodecanoate, methyl ethyl ketone peroxide, diisopropyl peroxycarbonate, cumene hydroperoxide, 2,4-dichlorobenzoyl peroxide, and lauroyl peroxide.

Furthermore, known chain transfer agents and polymerization inhibitors may be used.

The aqueous medium may contain an inorganic or organic dispersion stabilizer. As the dispersion stabilizer, a known dispersion stabilizer can be used.

Examples of inorganic dispersion stabilizers include phosphates such as hydroxyapatite, tricalcium phosphate, dicalcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; and alumina.

Meanwhile, examples of organic dispersion stabilizers include polyvinyl alcohol, gelatin, methyl cellulose, methylhydroxypropyl cellulose, ethyl cellulose, sodium salt of carboxymethyl cellulose, polyacrylic acid and salts thereof, and starch.

When an inorganic compound is used as the dispersion stabilizer, a commercially available product may be used as it is, but in order to obtain finer particles, the inorganic compound produced in an aqueous medium may be used.

For example, in the case of calcium phosphates such as hydroxyapatite and tricalcium phosphate, an aqueous phosphate solution may be mixed with an aqueous calcium salt solution under high agitation.

The aqueous medium may contain a surfactant. Known surfactants can be used as the surfactant. Examples include anionic surfactants such as sodium dodecylbenzene sulfate and sodium oleate, cationic surfactants, amphoteric surfactants, and nonionic surfactants.

### Methods for Measuring Various Physical Properties

The calculation and measurement methods for various physical properties of toner and toner materials are described below.

Method for Separating Toner Particles from Toner

When analyzing toner particles, where the surface of the toner particles has been treated with an external additive, the external additive is separated by the following method to obtain toner particles.

A total of 160 g of sucrose (manufactured by Kishida Chemical Co., Ltd.) is added to 100 mL of ion-exchanged water and dissolved using a hot water bath to prepare a concentrated sucrose solution. A total of 31 g of the concentrated sucrose solution and 6 mL of Contaminon N (anaqueous solution of 10% by mass of a neutral detergent for cleaning precision measuring instruments that has pH 7 and consists of a nonionic surfactant, an anionic surfactant, and an organic builder, manufactured by Wako Pure Chemical Industries, Ltd.) are added to a centrifuge tube to prepare a dispersion liquid.

A total of 1.0 g of toner is added to this dispersion, and the toner lumps are broken with a spatula or the like. The centrifuge tube is shaken with a shaker (AS-1N, sold by AS ONE Corporation) at 350 spm (strokes per minute) for 20 min. After shaking, the solution is transferred to a glass tube for a swing rotor (50 mL) and separated in a centrifuge (H-9R, manufactured by Kokusan Co., Ltd.) at 3500 rpm for 30 min. This operation separates the toner particles from the removed external additives.

The separation of toner particles and the aqueous solution is visually confirmed to be sufficient, and the toner particles separated in the top layer are collected with a spatula or the like. The collected toner is filtered through a vacuum filter and then dried in a dryer for 1 h or more to obtain toner particles. This operation is carried out multiple times to ensure the required amount.

### Method for Separating Tetrahydrofuran (THF) Insoluble Matter

Separation of THF insoluble matter from toner particles is performed according to the following procedure.

A total of 1.5 g of toner particles from which a THF insoluble matter is to be separated is accurately weighed (W [g]) and placed in a pre-weighed cylindrical filter paper (product name: No. 86R, size 28×100 mm, manufactured by Advantec Toyo Co., Ltd.) which is then set in a Soxhlet extractor.

Extraction is performed for 18 h using 200 mL of tetrahydrofuran (THF) as a solvent. At this time, the extraction is performed at a reflux rate such that the solvent extraction cycle occurs once about every 5 min.

After the extraction is complete, the cylindrical filter paper is removed, air-dried, and then vacuum-dried at 40° C. for 8 h, and the resulting extraction residue is obtained as the THF insoluble matter. Meanwhile, the THF soluble matter is obtained by thoroughly distilling off the THF from the THF solution after the above extraction by using an evaporator.

The recovered THF insoluble matter is subjected to DSC measurement, and where no melting point peak is present, it can be determined that the THF insoluble matter is an amorphous resin. Furthermore, the constituent components of the THF insoluble matter can be analyzed by using a combination of known methods such as Fourier transform infrared spectroscopy and pyrolysis gas chromatography to analyze the THF insoluble matter.

Method for Separating Crystalline Vinyl Resin, Amorphous Resin, and Release Agent from Toner Particle

Separation of the crystalline vinyl resin and the amorphous resin from the toner particle can be achieved by known methods, an example of which is shown below.

Gradient LC is used as a method for separating resin components from toner particles. In this analysis, separation can be achieved according to the polarity of the resins in the binder resin, regardless of molecular weight.

The toner particles are separated into the THF insoluble matter and THF soluble matter according to the above-mentioned Method for Separating Tetrahydrofuran (THF) Insoluble Matter.

Then, the THF soluble matter is dissolved in chloroform. The sample concentration is adjusted to 0.1% by mass in chloroform, and the solution is filtered through a 0.45 μm PTFE filter and used for measurement. The gradient polymer LC measurement conditions are shown below.
Apparatus: UltiMate 3000 (manufactured by Thermo Fisher Scientific Inc.)
Mobile phase: A chloroform (HPLC), B acetonitrile (HPLC)
Gradient: 2 min (A/B=0/100)→25 min (A/B=100/0)
(The gradient of the mobile phase change was set to be linear.)
Flow rate: 1.0 mL/min
Injection: 0.1% by mass×20 L
Column: Tosoh TSKgel ODS (4.6 mm diameter×150 mm×5 m)
Column temperature: 40° C.
Detector: Corona Charged Aerosol Detector (Corona-CAD) (manufactured by Thermo Fisher Scientific Inc.)

The resin components can be separated into two peaks according to polarity in the time-intensity graph obtained by the measurement. After that, the above measurement is performed again, and separation into two types of resin can be performed by taking out the fractions at the time when the valleys of the respective peaks are reached. The separated resins are subjected to DSC measurement, and the resin without a melting point peak is taken as the amorphous resin (mass W12 [g]).

The resin with a melting point peak contains the crystalline vinyl resin and the release agent, so it is necessary to separate them. A total of 200 mL of normal hexane is added to the resin with a melting point peak, and the resin is dissolved in normal hexane at room temperature for 24 h. The normal hexane solution is filtered, the filtrate is taken out, the solvent is removed using an evaporator, and vacuum drying is performed at 40° C. for 8 h to obtain a normal hexane soluble matter. Furthermore, here, the filtrate of the normal hexane solution is the normal hexane insoluble matter.

Next, the normal hexane soluble matter is fractionated by GPC (recycle HPLC) to separate components with a molecular weight of 10,000 or less as a release agent. The fractionation method is described hereinbelow.

A chloroform solution of the normal hexane soluble matter is prepared. The resulting solution is then filtered through a solvent-resistant membrane filter “MyShori Disc” (manufactured by Tosoh Corporation) with a pore size of 0.2 μm to obtain a sample solution. The sample solution is adjusted so that the concentration of components soluble in chloroform is 1.0% by mass. Using this sample solution, fractionation is performed by GPC (recycle HPLC) under the following conditions. The resulting solution is vacuum dried to obtain the release agent (mass W3 [g]).
Apparatus: LC-Sakura NEXT (manufactured by Japan Analytical Industry Co., Ltd.)
Column: JAIGEL 2H, 4H (manufactured by Japan Analytical Industry Co., Ltd.)
Eluent: chloroform
Flow rate: 10.0 mL/min
Oven temperature: 40.0° C.
Sample injection amount: 1.0 mL
Fractionation conditions: fractionation is performed after the elution time when the molecular weight becomes 10,000 on the molecular weight calibration curve

For the fractionation conditions, a molecular weight calibration curve created using standard polystyrene resins (product names “TSK Standard Polystyrene F-850, F-450, F-288, F-128, F-80, F-40, F-20, F-10, F-4, F-2, F-1, A-5000, A-2500, A-1000, A-500”, manufactured by Tosoh Corporation) is used.

In the above operation, the normal hexane insoluble matter and the component of the normal hexane soluble matter with a molecular weight exceeding 10,000 represent the crystalline vinyl resin (mass W11 [g]). A method for fractionating the component of the normal hexane soluble matter with a molecular weight exceeding 10,000 is the same as the method for fractionating the release agent, except that the fractionation conditions are changed to “fractionation before the elution time at which the molecular weight becomes 10,000” on the molecular weight calibration curve. The resulting fractionation solution is dried in a vacuum to obtain a crystalline vinyl resin.

The total mass of the crystalline vinyl resin obtained by vacuum drying the normal hexane insoluble matter and the crystalline vinyl resin obtained by vacuum drying the fractionation solution is taken as mass W11 [g].

### Measurement of Content Ratio of Each Component in Toner Particle

The content ratio of each component in the toner particle is calculated by the following formulas (7) and (8) from the masses described in the above-mentioned “Method for Separating Crystalline Vinyl Resin, Amorphous Resin, and Release Agent from Toner Particle”.

[Content ratio of crystalline vinyl resin based on the mass of binder resin: Ratio I (unit: % by mass)]

$$I = ( W 11 / ( W 11 + W 12 ) ) \times 100 \qquad ( 7 )$$

[Content ratio of release agent based on the mass of crystalline resin: Ratio L (unit: % by mass)]

$$L = ( W 3 / W 11 ) \times 100 \qquad ( 8 )$$

### Method for Measuring Molecular Weight of Release Agent

The molecular weight distribution of the release agent is measured by gel permeation chromatography (GPC) as follows.

Special grade 2,6-di-t-butyl-4-methylphenol (BHT) is added to o-dichlorobenzene for gel chromatography to a concentration of 1.0 g/L and dissolved at room temperature. The release agent and the o-dichlorobenzene with added BHT are placed in a sample bottle, which is then heated on a hot plate set to 150° C. to dissolve the release agent. Once the release agent has dissolved, the solution is placed in a pre-heated filter unit and arranged in the GPC device body. The solution that has passed through the filter unit is the GPC sample. The sample solution is adjusted to a concentration of approximately 0.15% by mass. This sample solution is used for measurements under the following conditions.
Apparatus: HLC-8121GPC/HT (manufactured by Tosoh Corporation)
Detector: high-temperature RI
Column: TSKgel GMHHR-H HT 2-unit (manufactured by Tosoh Corporation)
Temperature: 135.0° C.
Solvent: o-dichlorobenzene for gel chromatography (with 1.0 g/L BHT added)
Flow rate: 1.0 mL/min
Injection amount: 0.4 mL

To calculate the molecular weight of the release agent, a molecular weight calibration curve created using standard polystyrene resins (for example, product names “TSK Standard Polystyrene F-850, F-450, F-288, F-128, F-80, F-40, F-20, F-10, F-4, F-2, F-1, A-5000, A-2500, A-1000, and A-500”, manufactured by Tosoh Corporation) is used.

In the measured molecular weight distribution, in a differential molecular weight distribution curve obtained by RI detection in which the horizontal axis represents log M, which is the logarithm of the molecular weight, and the vertical axis represents a value [dW/d(log M)] obtained by differentiating a concentration fraction by the logarithm of the molecular weight, the molecular weight at the peak position is the peak molecular weight Mp. The ratio of the area of a peak in a region of molecular weights of 700 to 1,000,000 to the total area of peaks in a region of molecular weights of 1,000,000 or less in the differential molecular weight distribution curve is the ratio H.

### Method for Measuring Content Ratio of Various Monomer Units Such as Monomer Unit (a) in Resin and the Number of Carbon Atoms in Alkyl Groups

The content ratio of various monomer units such as the monomer unit (a) in the resin and the number of carbon atoms in alkyl groups are measured by ¹H-NMR under the following conditions. The crystalline vinyl resin fractionated by the above method can be used as the measurement sample.

Measurement device: FT NMR device JNM-EX400 (manufactured by JEOL Ltd.)
Measurement frequency: 400 MHz
Pulse condition: 5.0 s
Frequency range: 10,500 Hz
Number of times of accumulation: 64
Measurement temperature: 30° C.

Sample: the sample is prepared by placing 50 mg of the measurement sample in a sample tube with an inner diameter of 5 mm, adding deuterated chloroform (CDCl₃) as a solvent, and dissolving the measurement sample in a thermostatic bath at 40° C. The obtained ¹H-NMR chart is analyzed to identify the structure of each monomer unit. Here, as an example, the measurement of the content ratio of the monomer unit (a) in the crystalline vinyl resin and the number of carbon atoms of the alkyl groups is described. In the obtained ¹H-NMR chart, a peak that is independent of the peaks attributed to components of other monomer units is selected from the peaks that are attributed to the components of the monomer unit (a), and the integral value S1 of this peak is calculated. The integral values of the other monomer units contained in the crystalline vinyl resin are calculated in the same manner.

For example, where the monomer units constituting the crystalline vinyl resin are the monomer unit (a) and one other monomer unit, the content ratio of the monomer unit (a) is obtained as follows using the integral value S1 and the integral value S2 of the peak of the other monomer unit. Here, n1 and n2 are the numbers of hydrogen atoms in the components to which the peaks of interest for each segment belong.

$$Content ratio of the monomer unit ( a ) ( mol \% ) = \{ ( S 1 / n 1 ) / ( ( S 1 / n 1 ) + ( S 2 / n 2 ) ) \} \times 100$$

When there are two or more other monomer units, the content ratio of the monomer unit (a) can be also calculated in the same manner (using S3 . . . Sx, n3 . . . nx).

The number of carbon atoms in the alkyl group can be calculated from the integral ratio of proton peaks in the ¹H-NMR chart.

When a polymerizable monomer that does not contain hydrogen atoms in components other than the vinyl group is used, the measurement nucleus is set to ¹³C using ¹³C-NMR, measurement is performed in a single pulse mode, and calculation is performed in the same manner as in ¹H-NMR.

The proportion (mol %) of each monomer unit calculated by the above method is multiplied by the molecular weight of each monomer unit to convert the content ratio of each monomer unit to “% by mass”. In this way, the ratio J of the monomer unit (a) represented by the above formula (1) is calculated using the following formula (9) based on the mass of the crystalline vinyl resin.

[Content ratio of monomer unit (a) based on the mass of crystalline vinyl resin: Ratio J (unit: % by mass)]

$$J = \{ ( S 1 / n 1 ) \times M 1 / ( ( S 1 / n 1 ) \times M 1 + ( S 2 / n 2 ) \times M 2 ) \} \times 100 \qquad ( 9 )$$

In addition, where a monomer unit having an alkyl group with 16 to 30 carbon atoms is present in addition to the monomer unit (a) represented by formula (1), the content ratio (ratio K) of the monomer unit (a) in the monomer units having an alkyl group with 16 to 30 carbon atoms is calculated as follows. For example, where the units having an alkyl group with 16 to 30 carbon atoms are the monomer unit (a) and one other monomer unit, the content ratio of the monomer unit (a) is calculated by the following formula (10) using the integral value S1 and the integral value S3 of the peak of the other monomer unit.

[Mass ratio of monomer unit (a) in monomer units having an alkyl group with 16 to 30 carbon atoms: ratio K (unit: % by mass)]

$$K = \{ ( S 1 / n 1 ) \times M 1 / ( ( S 1 / n 1 ) \times M 1 + ( S 3 / n 3 ) \times M 3 ) \} \times 100 \qquad ( 10 )$$

Here, M1 and M3 are the molecular weights of the respective monomer units. The same method is used to perform measurement for the amorphous vinyl resins.

Method for Calculating Solubility Parameters (SP Values)

The SP values of the resin are calculated as follows according to the calculation method proposed by Fedors.

First, the SP values of the monomer units that constitute the resin are calculated in the following manner. Here, the monomer unit that constitutes the resin refers to the molecular structure in the state in which the double bond of the monomer used when obtaining the resin by polymerization is cleaved by polymerization.

For example, when calculating the SP value (am) (J/cm³)^{0.5} of a monomer unit, the evaporation energy (Δei) (J/mol) and molar volume (Δvi) (cm³/mol) for the atom or atomic group in the molecular structure of the monomer unit are obtained from the table in “Polym. Eng. Sci., 14(2), 147-154 (1974)”, and the calculation is performed by the following formula (11):

$$σ m = {( \sum Δ ei / \sum Δ vi )}^{0.5} \qquad ( 11 )$$

The SP value of a resin is calculated by calculating the evaporation energy (Δei) and molar volume (Δvi) of the monomer units that make up the resin for each monomer unit. Then, the product of each calculation result with the molar ratio (j) of each monomer unit in the resin is calculated, and the sum total of the evaporation energies of the monomer units is divided by the sum total of the molar volumes. The calculation is performed by the following formula (12).

$$σ p = {\{ ( \sum j \times \sum Δ ei ) / ( \sum j \times \sum Δ vi ) \}}^{0.5} \qquad ( 12 )$$

For example, assuming that a resin is composed of two types of monomer units, X and Y, where the composition ratio of each monomer unit is Wx and Wy (% by mass), the molecular weight is Mx and My, the evaporation energy is Δei(X) and Δei(Y), and the molar volume is Δvi(X) and Δvi(Y), then the molar ratio (j) of each monomer unit is Wx/Mx and Wy/My, respectively, and the SP value (σp) of this resin is given by the following formula (13).

$$σ p = {[ \{ ( Wx / Mx ) \times Δ ei ( X ) + Wy / My \times Δ ei ( Y ) \} / \{ ( Wx / Mx ) \times Δ vi ( X ) + Wy / My \times Δ vi ( Y ) \} ]}^{0.5} \qquad ( 13 )$$

Furthermore, when two or more types of resin are mixed, the SP value (σM) of the mixture is calculated as the product of the mass composition ratio (Wi) of the mixture and the SP value (σi) of each resin by the following formula (14).

$$σ M = \sum ( Wi \times σ i ) \qquad ( 14 )$$

The SP value of the release agent can also be calculated in the same way as the SP value of the resin above.

### Method for Measuring Acid Value

Acid value is the number of milligrams of potassium hydroxide required to neutralize an acid contained in 1 g of sample. The acid value of resin is measured according to JIS K 0070-1992, specifically, according to the following procedure.

### (1) Preparation of Reagents

A total of 1.0 g of phenolphthalein is dissolved in 90 mL of ethyl alcohol (95% by volume), and ion-exchanged water is added to make 100 mL and obtain a phenolphthalein solution.

A total of 7 g of special grade potassium hydroxide is dissolved in 5 mL of water, and ethyl alcohol (95% by volume) is added to make 1 L. The solution is placed in an alkali-resistant container to avoid contact with carbon dioxide and the like, allowed to stand for 3 days, and then filtered to obtain a potassium hydroxide solution.

The obtained potassium hydroxide solution is stored in an alkali-resistant container. The factor of the potassium hydroxide solution is obtained by placing 25 mL of 0.1 mol/L hydrochloric acid in an Erlenmeyer flask, adding a few drops of the phenolphthalein solution, titrating with the potassium hydroxide solution, and determining the amount of potassium hydroxide solution required for neutralization. The 0.1 mol/L hydrochloric acid used is prepared in accordance with JIS K 8001-1998.

### (2) Procedure

### (A) Main Test

A total of 2.0 g of a sample (for example, the crystalline vinyl resin) is weighed out into a 200 mL Erlenmeyer flask, 100 mL of a toluene/ethanol (2:1) mixed solution is added, and dissolution is performed for 5 h.

Then, a few drops of the phenolphthalein solution is added as an indicator, and titration is performed using the potassium hydroxide solution. The end point of the titration is when the light red color of the indicator continues for 30 sec.

### (B) Blank Test

The titration is performed in the same manner as above, except that no sample is used (that is, only a toluene/ethanol (2:1) mixed solution is used).

(3) The Obtained Results are Substituted into the Following Formula to Calculate the Acid Value.

$$A = [ ( C - B ) \times f \times 5.61 ] / S$$

Here, A is the acid value (mg KOH/g), B is the amount of potassium hydroxide solution added in the blank test (mL), C is the amount of potassium hydroxide solution added in the main test (mL), f is the factor of the potassium hydroxide solution, and S is the mass of the sample (g).

### Method for Measuring Peak Temperature of Endothermic Peak

The peak temperature of the endothermic peak is measured using a DSC Q2000 (manufactured by TA Instruments) under the following conditions.
Heating rate: 10° C./min
Measurement start temperature: 20° C.
Measurement end temperature: 180° C.

The melting points of indium and zinc are used to correct the temperature of the detection unit of the device, and the heat of fusion of indium is used to correct the amount of heat.

Specifically, 5 mg of the sample is precisely weighed and placed in an aluminum pan, and differential scanning calorimetry is performed. An empty aluminum pan is used as a reference. During the temperature rise process, the temperature is raised to 180° C. at a rate of 10° C./min. The peak temperature is calculated from each peak, and the peak temperature is set as the melting point of the release agent.

### Method for Measuring Viscoelasticity

### Method for Measuring Storage Elastic Modulus G^{′} and tan δ

The storage elastic modulus G^{′} and tan δ are measured using a viscoelasticity measuring device (rheometer) ARES (manufactured by Rheometric Scientific, Inc.).

The outline of the measurement is described in the ARES operation manuals 902-30004 (edition of August 1997) and 902-00153 (edition of July 1993) issued by Rheometric Scientific, Inc. and is as follows.
Measurement jig: torsion rectangular
Measurement sample: for the toner, a sample in the form of a rectangular parallelepiped with a width of 12 mm, height of 20 mm, and thickness of 2.5 mm is prepared using a pressure molding machine (25 kN is maintained for 30 min at room temperature). The pressure molding machine used is a 100 kN press NT-100H manufactured by NPa System Co., Ltd.

The jig and sample are allowed to stand at room temperature (23° C.) for 1 h, and the sample is then attached to the jig. See the FIGURE. As shown in the FIGURE, the sample is fixed so that the measurement portion has a width of 12 mm, a thickness of 2.5 mm, and a height of 10 mm. After regulating the temperature to a measurement start temperature of 30° C. over 10 min, the measurement is performed with the following settings.
Measurement frequency: 6.28 rad/s
Measurement strain setting: the initial value is set to 0.1% and the measurement is performed in automatic measurement mode
Sample elongation correction: adjustment is performed in automatic measurement mode
Measurement temperature: the temperature is raised from 30° C. to 150° C. at a rate of 2° C. per minute
Measurement interval: viscoelasticity data are measured every 30 sec, i.e., every 1° C.

Data are transferred through an interface to RSI Orchestrator (control, data collection and analysis software) (manufactured by Rheometric Scientific, Inc.) running on Microsoft Windows (registered trademark) 2000.

Among the measurement data, the temperature at which the storage elastic modulus G^{′} of the measurement data becomes 1.0×10⁷ Pa is T1 [° C.], the ratio (tan δ) of the loss elastic modulus G″ to the storage elastic modulus G^{′} at temperature T1 [° C.] is tan δ (T1), and the ratio of the loss elastic modulus G″ to the storage elastic modulus G′ at temperature T1−10 [° C.] is tan δ (T1−10).

### EXAMPLES

The present disclosure will be specifically explained below using examples, but these do not limit the present disclosure in any way. In the following formulations, parts are by mass unless otherwise specified.

Preparation of Polymerizable Monomer (a-1)

A total of 727.3 parts of cetanol, 174.1 parts of fumaric acid, 2.5 parts of dibutyltin oxide, and 1 part of 2,6-di-tert-butyl-p-cresol were added to a pressurized reaction vessel equipped with a stirrer, a temperature controller, a thermometer, an air introduction tube, a pressure reducing device, and a water reducer, and the components were homogenized by stirring at 120° C. After that, the temperature was raised to 165° C., and the mixture was esterified under reduced pressure at 21 kPa for 3 h while removing distilled water. After confirming that the acid value was less than 30.0 mg KOH/g, the mixture was esterified under reduced pressure at 3 kPa or less for 12 h while removing distilled water. The esterification product was taken out to obtain a polymerizable monomer (a-1).

Preparation of Polymerizable Monomers (a-2) to (a-12)

Polymerizable monomers (a-2) to (a-12) were produced in the same manner as in the preparation example of the polymerizable monomer (a-1), except that the types and amounts added of raw materials were changed as shown in Table 1. The compositions of polymerizable monomers (a-2) to (a-12) are shown in Table 1.

TABLE 1

| | Unsaturated polyvalent | | | | | | | |
|---|---|---|---|---|---|---|---|---|
| | carboxylic acid | | Long-chain alcohol | | | | | |
| Polymerizable | | Number | | Number | Structure of monomer unit (a) | | | |
| monomer | Type | of parts | Type | of parts | R1 | R2 | R3 | R4 |
| (a-1) | Fumaric acid | 175.0 | Cetanol | 727.0 | —COOC16H33 | H | H | —COOC16H33 |
| (a-2) | Fumaric acid | 175.0 | Stearyl alcohol | 811.0 | —COOC18H37 | H | H | —COOC18H37 |
| (a-3) | Fumaric acid | 175.0 | Behenyl alcohol | 979.0 | —COOC22H45 | H | H | —COOC22H45 |
| (a-4) | Fumaric acid | 175.0 | Octacosanol | 1232.0 | —COOC28H57 | H | H | —COOC28H57 |
| (a-5) | Fumaric acid | 175.0 | Myricyl alcohol | 1316.0 | —COOC30H61 | H | H | —COOC30H61 |
| (a-6 | Maleic acid | 175.0 | Behenyl alcohol | 979.0 | —COOC22H45 | H | —COOC22H45 | H |
| (a-7) | Citraconic acid | 196.0 | Behenyl alcohol | 979.0 | —COOC22H45 | CH3 | —COOC22H45 | H |
| (a-8) | Itaconic acid | 196.0 | Behenyl alcohol | 979.0 | —COOC22H45 | —(CH2) —COOC22H45 | H | H |
| (a-9) | trans-Aconitic acid | 175.0 | Behenyl alcohol | 979.0 | —COOC22H45 | —(CH2) —COOC22H45 | H | —COOC22H45 |
| (a-10) | Fumaric acid | 178.0 | Behenyl alcohol | 978.0 | —COOC22H45 | H | H | —COOC22H45 |
| (a-11) | Fumaric acid | 182.5 | Behenyl alcohol | 978.0 | —COOC22H45 | H | H | —COOC22H45 |
| (a-12) | Fumaric acid | 175.0 | Lauryl alcohol | 559.0 | —COOC12H25 | H | H | —COOC12H25 |

A total of 120.0 parts of xylene and 80.0 parts of the polymerizable monomer (a-1) were charged into an autoclave, and the temperature was raised to 135° C. while stirring in a sealed state, and then the pressure was released. Thereafter, the temperature was raised to 155° C. while stirring in a sealed state. A mixed solution of 14.0 parts of methacrylonitrile, 6.0 parts of styrene, 1.6 parts of di-t-butyl peroxide, and 60.0 parts of xylene was dropwise added over 3 h while controlling the temperature inside the autoclave to 155° C., and polymerization was carried out. After dropwise addition, the dropping line was washed with 20.0 parts of xylene. After holding at the same temperature for another 2.2 h and then cooling to 70° C., 12.8 parts of di-t-butyl peroxide was added and reacted. The solvent was then removed at 170° C. for 3 h under reduced pressure of 0.5 kPa to 2.5 kPa to obtain a crystalline vinyl resin (A-1). It was confirmed that the crystalline vinyl resin (A1) is a crystalline resin that shows a clear endothermic peak in differential scanning calorimetry (DSC) measurements.

### Preparation of Crystalline Vinyl Resins (A2) to (A25)

Crystalline vinyl resins (A2) to (A25) were produced in the same manner as the crystalline vinyl resin (A1), except that the types and amounts added of raw materials were changed as shown in Table 2. It was confirmed that the crystalline vinyl resins (A2) to (A25) are crystalline resins that show a clear endothermic peak in differential scanning calorimetry (DSC) measurements. The compositions and physical properties of the crystalline vinyl resins (A2) to (A25) are shown in Table 2.

TABLE 2

| | First | | Second | | Third | |
|---|---|---|---|---|---|---|
| Crystalline | polymerizable | | polymerizable | | polymerizable | |
| vinyl resin | monomer | | monomer | | monomer | |
| No. | Type | Amount | Type | Amount | Type | Amount |
| A1 | Polymerizable monomer (a-1) | 80.0 | Methacrylonitrile | 14.0 | Styrene | 6.0 |
| A2 | Polymerizable monomer (a-2) | 80.0 | Methacrylonitrile | 14.0 | Styrene | 6.0 |
| A3 | Polymerizable monomer (a-3) | 80.0 | Methacrylonitrile | 14.0 | Styrene | 6.0 |
| A4 | Polymerizable monomer (a-4) | 80.0 | Methacrylonitrile | 14.0 | Styrene | 6.0 |
| A5 | Polymerizable monomer (a-5) | 80.0 | Methacrylonitrile | 14.0 | Styrene | 6.0 |
| A6 | Polymerizable monomer (a-6) | 80.0 | Methacrylonitrile | 14.0 | Styrene | 6.0 |
| A7 | Polymerizable monomer (a-7) | 80.0 | Methacrylonitrile | 14.0 | Styrene | 6.0 |
| A8 | Polymerizable monomer (a-8) | 80.0 | Methacrylonitrile | 14.0 | Styrene | 6.0 |
| A9 | Polymerizable monomer (a-9) | 80.0 | Methacrylonitrile | 14.0 | Styrene | 6.0 |
| A10 | Polymerizable monomer (a-3) | 45.0 | Methacrylonitrile | 14.0 | Styrene | 41.0 |
| A11 | Polymerizable monomer (a-3) | 30.0 | Methacrylonitrile | 14.0 | Styrene | 56.0 |
| A12 | Polymerizable monomer (a-3) | 20.0 | Methacrylonitrile | 14.0 | Styrene | 66.0 |
| A13 | Polymerizable monomer (a-3) | 5.5 | Methacrylonitrile | 14.0 | Styrene | 80.5 |
| A14 | Polymerizable monomer (a-3) | 4.0 | Methacrylonitrile | 14.0 | Styrene | 82.0 |
| A15 | Polymerizable monomer (a-3) | 64.0 | Methacrylonitrile | 14.0 | Styrene | 6.0 |
| A16 | Polymerizable monomer (a-3) | 40.0 | Methacrylonitrile | 14.0 | Styrene | 6.0 |
| A17 | Polymerizable monomer (a-3) | 24.0 | Methacrylonitrile | 14.0 | Styrene | 6.0 |
| A18 | Polymerizable monomer (a-10) | 80.0 | Methacrylonitrile | 14.0 | Styrene | 6.0 |
| A19 | Polymerizable monomer (a-11) | 80.0 | Methacrylonitrile | 14.0 | Styrene | 6.0 |
| A20 | Polymerizable monomer (a-3) | 80.0 | Styrene | 20.0 | None | — |
| A21 | Polymerizable monomer (a-3) | 80.0 | Acrylamide | 14.0 | Styrene | 6.0 |
| A22 | Polymerizable monomer (a-3) | 80.0 | Methyl acrylate | 14.0 | Styrene | 6.0 |
| A23 | Polymerizable monomer (a-3) | 80.0 | Acrylonitrile | 14.0 | Styrene | 6.0 |
| A24 | Polymerizable monomer (a-12) | 80.0 | Methacrylonitrile | 14.0 | Styrene | 6.0 |
| A25 | None | — | Methacrylonitrile | 14.0 | Styrene | 20.0 |

| | Fourth | | | | | \|SPb − |
|---|---|---|---|---|---|---|
| Crystalline | polymerizable | | Ratio J | Ratio K | | SPa\| |
| vinyl resin | monomer | | (% by | (% by | Acid | (J/ |
| No. | Type | Amount | mass) | mass) | value | m³)^{0.5} |
| A1 | None | — | 80.0 | 100.0 | 0.9 | 7.4 |
| A2 | None | — | 80.0 | 100.0 | 0.8 | 7.5 |
| A3 | None | — | 80.0 | 100.0 | 0.7 | 7.7 |
| A4 | None | — | 80.0 | 100.0 | 0.5 | 7.8 |
| A5 | None | — | 80.0 | 100.0 | 0.5 | 7.9 |
| A6 | None | — | 80.0 | 100.0 | 0.7 | 7.7 |
| A7 | None | — | 80.0 | 100.0 | 0.6 | 7.8 |
| A8 | None | — | 80.0 | 100.0 | 0.6 | 7.7 |
| A9 | None | — | 80.0 | 100.0 | 0.7 | 7.7 |
| A10 | None | — | 45.0 | 100.0 | 0.4 | 7.7 |
| A11 | None | — | 30.0 | 100.0 | 0.3 | 7.7 |
| A12 | None | — | 20.0 | 100.0 | 0.2 | 7.7 |
| A13 | None | — | 5.5 | 100.0 | 0.1 | 7.7 |
| A14 | None | — | 4.0 | 100.0 | 0.1 | 7.7 |
| A15 | Behenyl acrylate | 16.0 | 64.0 | 80.0 | 0.6 | 7.7 |
| A16 | Behenyl acrylate | 40.0 | 40.0 | 50.0 | 0.4 | 7.7 |
| A17 | Behenyl acrylate | 56.0 | 24.0 | 30.0 | 0.2 | 7.7 |
| A18 | None | — | 80.0 | 100.0 | 3.0 | 7.7 |
| A19 | None | — | 80.0 | 100.0 | 6.1 | 7.7 |
| A20 | None | — | 80.0 | 100.0 | 0.7 | 1.8 |
| A21 | None | — | 80.0 | 100.0 | 0.7 | 21.0 |
| A22 | None | — | 80.0 | 100.0 | 0.7 | 3.3 |
| A23 | None | — | 80.0 | 100.0 | 0.7 | 11.2 |
| A24 | None | — | — | — | 1.0 | 7.1 |
| A25 | Behenyl acrylate | 80.0 | — | — | 1.0 | — |

In the table, the ratio J indicates the content ratio (% by mass) of the monomer unit (a) represented by formula (1) based on the mass of the crystalline vinyl resin.

The ratio K indicates the content ratio (% by mass) of the monomer unit (a) among monomer units having an alkyl group with 16 to 30 carbon atoms, including the monomer unit (a), in the crystalline vinyl resin.

The unit of acid value is mg KOH/g.

### Preparation of Amorphous Resin B1

The following materials were placed in a reaction vessel equipped with a reflux condenser, a stirrer, a thermometer, and a nitrogen introduction tube under a nitrogen atmosphere.
Toluene 100.0 parts by mass
Monomer composition 100.0 parts by mass
   (The monomer composition is a mixture of the following monomers in the ratios shown below)
(Butyl acrylate 25.0 parts by mass)
(Styrene 75.0 parts by mass)
Polymerization initiator: t-butyl peroxypivalate (Perbutyl PV, manufactured by NOF Corp.) 0.5 parts by mass

The reaction vessel was heated to 70° C. while stirring at 200 rpm, and the polymerization reaction was carried out for 12 h to obtain a solution in which the polymer of the monomer composition was dissolved in toluene. Next, the temperature of the solution was lowered to 25° C., and the solution was poured into 1000.0 parts by mass of methanol while stirring to precipitate the methanol insoluble matter. The resulting methanol insoluble matter was filtered off, washed with methanol, and then vacuum dried at 40° C. for 24 h to obtain amorphous resin B1.

### Preparation of Release Agent 10

Solvent: toluene 100.0 parts by mass
1-Triacontene 100.0 parts by mass

The above materials and the following materials were added to a heated and dried autoclave under a hydrogen atmosphere, and polymerization was carried out at 160° C. for 130 min.
Triisobutylaluminum 0.5 mmol
(1,2′-Dimethylsilylene) (2,1′-dimethylsilylene)bis(3-trimethylsilylmethylindenyl) zirconium dichloride 2 mol
Dimethylanilinium tetrakispentafluorophenylborate 8 mol

After the polymerization reaction had been completed, the precipitated reaction product was separated at 25° C., washed with acetone, and then dried under heating and reduced pressure to obtain a poly-α-olefin wax as a release agent 10. The release agent 10 had a peak molecular weight Mp of 1900 and a peak top temperature of the temperature-endothermic curve of 70° C.

### Example 1

### Production of Toner by Suspension Polymerization Method

### Production of Toner Particles 1

n-Butyl acrylate 16.2 parts by mass
Styrene 48.8 parts by mass
Colorant: Pigment Blue 15:3 6.5 parts by mass

A mixture of the above materials was prepared. The mixture was placed in an attritor (manufactured by Nippon Coke Corporation) and dispersed for 2 h at 200 rpm using zirconia beads with a diameter of 5 mm to obtain a raw material dispersion liquid.

Meanwhile, 735.0 parts by mass of ion-exchanged water and 16.0 parts by mass of trisodium phosphate (12-hydrate) were added to a container equipped with a high-speed stirring device Homomixer (manufactured by Primix Corporation) and a thermometer, and the temperature was raised to 60° C. while stirring at 12,000 rpm. An aqueous calcium chloride solution prepared by dissolving 9.0 parts by mass of calcium chloride (dihydrate) in 65.0 parts by mass of ion-exchanged water was added thereto, and stirring was carried out at 12,000 rpm for 30 min while keeping the temperature at 60° C. Then, 10% hydrochloric acid was added thereto to adjust the pH to 6.0, yielding an aqueous medium in which an inorganic dispersion stabilizer containing hydroxyapatite was dispersed in water.

The raw material dispersion liquid was then transferred to a container equipped with a stirrer and a thermometer, and the temperature was raised to 60° C. while stirring at 100 rpm.
Crystalline vinyl resin (A3) 35.0 parts by mass
Release agent 1 (dipentaerythritol stearate wax, manufactured by Nisshin Oillio Co., Ltd.) 9.0 parts by mass

The above materials were added and stirred at 100 rpm for 30 min while keeping the temperature at 60° C., after which 5.0 parts by mass of t-butyl peroxypivalate (Perbutyl PV, manufactured by NOF Corp.) was added as a polymerization initiator and then stirring was performed for another minute. The mixture was then charged into the aqueous medium being stirred at 12,000 rpm with the high-speed stirring device. The stirring was continued for 20 min at 12,000 rpm with the high-speed stirring device while keeping the temperature at 60° C., and a granulation liquid was obtained.

The granulation liquid was transferred to a reaction vessel equipped with a reflux condenser, a stirrer, a thermometer, and a nitrogen introduction tube, and the temperature was raised to 70° C. while stirring at 150 rpm under a nitrogen atmosphere. The polymerization reaction was carried out at 150 rpm for 12 h while keeping the temperature at 70° C. to obtain a toner particle dispersion liquid.

The obtained toner particle dispersion liquid was cooled to 45° C. while stirring at 150 rpm, and then heat-treated for 5 h while keeping the temperature at 45° C. After that, while maintaining the stirring, dilute hydrochloric acid was added until the pH reached 1.5 to dissolve the dispersion stabilizer. The solid fraction was filtered off and thoroughly washed with ion-exchanged water, and then vacuum-dried at 30° C. for 24 h to obtain toner particles 1.

### Preparation of Toner 1

A total of 2.0 parts by mass of silica fine particles (hydrophobized with hexamethyldisilazane, number-average particle diameter of primary particles: 10 nm, BET specific surface area: 170 m²/g) were added as an external additive to 100.0 parts by mass of toner particles 1, and mixing was performed for 15 min at 3000 rpm using a Henschel mixer (manufactured by Nippon Coke Corporation) to obtain toner 1. The obtained toner 1 was evaluated by the following method. The physical properties of toner 1 are shown in Tables 5-1 and 5-2, and the evaluation results are shown in Table 6-1.

### Examples 2 to 47

Toner particles 2 to 47 were obtained in the same manner as in Example 1, except that the type and amount added of crystalline vinyl resin, the type and amount added of polymerizable monomers, the type and amount added of release agent, and the amount added of crosslinking agent used were changed as shown in Tables 3-1, 3-2 and 3-3. The type and physical properties of the release agent are shown in Table 4.

Furthermore, the external addition was performed in the same manner as in Example 1 to obtain to obtain toners 2 to 47. The obtained toners 2 to 47 were evaluated by the methods shown below. The physical properties of the toners are shown in Tables 5-1 and 5-2, and the evaluation results are shown in Tables 6-1 and 6-2.

TABLE 3-1

| | | | Binder resin | |
|---|---|---|---|---|
| | | | Crystalline vinyl resin A | |
| | | | | Amount |
| | | | | added |
| Example No. | Toner No. | Production method | Type | (parts) |
| Example 1 | 1 | Suspension polymerization method | Crystalline vinyl resin A3 | 35.0 |
| Example 2 | 2 | Suspension polymerization method | Crystalline vinyl resin A3 | 90.0 |
| Example 3 | 3 | Suspension polymerization method | Crystalline vinyl resin A3 | 80.0 |
| Example 4 | 4 | Suspension polymerization method | Crystalline vinyl resin A3 | 55.0 |
| Example 5 | 5 | Suspension polymerization method | Crystalline vinyl resin A3 | 28.0 |
| Example 6 | 6 | Suspension polymerization method | Crystalline vinyl resin A3 | 21.0 |
| Example 7 | 7 | Suspension polymerization method | Crystalline vinyl resin A3 | 10.0 |
| Example 8 | 8 | Suspension polymerization method | Crystalline vinyl resin A1 | 35.0 |
| Example 9 | 9 | Suspension polymerization method | Crystalline vinyl resin A2 | 35.0 |
| Example 10 | 10 | Suspension polymerization method | Crystalline vinyl resin A4 | 35.0 |
| Example 11 | 11 | Suspension polymerization method | Crystalline vinyl resin A5 | 35.0 |
| Example 12 | 12 | Suspension polymerization method | Crystalline vinyl resin A6 | 35.0 |
| Example 13 | 13 | Suspension polymerization method | Crystalline vinyl resin A7 | 35.0 |
| Example 14 | 14 | Suspension polymerization method | Crystalline vinyl resin A8 | 35.0 |
| Example 15 | 15 | Suspension polymerization method | Crystalline vinyl resin A9 | 35.0 |
| Example 16 | 16 | Suspension polymerization method | Crystalline vinyl resin A10 | 35.0 |
| Example 17 | 17 | Suspension polymerization method | Crystalline vinyl resin A11 | 35.0 |
| Example 18 | 18 | Suspension polymerization method | Crystalline vinyl resin A12 | 35.0 |
| Example 19 | 19 | Suspension polymerization method | Crystalline vinyl resin A13 | 35.0 |
| Example 20 | 20 | Suspension polymerization method | Crystalline vinyl resin A15 | 35.0 |
| Example 21 | 21 | Suspension polymerization method | Crystalline vinyl resin A16 | 35.0 |
| Example 22 | 22 | Suspension polymerization method | Crystalline vinyl resin A17 | 35.0 |
| Example 23 | 23 | Suspension polymerization method | Crystalline vinyl resin A18 | 35.0 |
| Example 24 | 24 | Suspension polymerization method | Crystalline vinyl resin A19 | 35.0 |
| Example 25 | 25 | Suspension polymerization method | Crystalline vinyl resin A20 | 35.0 |
| Example 26 | 26 | Suspension polymerization method | Crystalline vinyl resin A21 | 35.0 |
| Example 27 | 27 | Suspension polymerization method | Crystalline vinyl resin A22 | 35.0 |
| Example 28 | 28 | Suspension polymerization method | Crystalline vinyl resin A23 | 35.0 |
| Example 29 | 29 | Suspension polymerization method | Crystalline vinyl resin A3 | 35.0 |
| Example 30 | 30 | Suspension polymerization method | Crystalline vinyl resin A3 | 35.0 |
| Example 31 | 31 | Suspension polymerization method | Crystalline vinyl resin A3 | 35.0 |
| Example 32 | 32 | Suspension polymerization method | Crystalline vinyl resin A3 | 35.0 |
| Example 33 | 33 | Suspension polymerization method | Crystalline vinyl resin A3 | 35.0 |
| Example 34 | 34 | Suspension polymerization method | Crystalline vinyl resin A3 | 35.0 |
| Example 35 | 35 | Suspension polymerization method | Crystalline vinyl resin A3 | 35.0 |
| Example 36 | 36 | Suspension polymerization method | Crystalline vinyl resin A3 | 35.0 |
| Example 37 | 37 | Suspension polymerization method | Crystalline vinyl resin A3 | 35.0 |
| Example 38 | 38 | Suspension polymerization method | Crystalline vinyl resin A3 | 35.0 |
| Example 39 | 39 | Suspension polymerization method | Crystalline vinyl resin A3 | 35.0 |
| Example 40 | 40 | Suspension polymerization method | Crystalline vinyl resin A3 | 35.0 |
| Example 41 | 41 | Suspension polymerization method | Crystalline vinyl resin A3 | 35.0 |
| Example 42 | 42 | Suspension polymerization method | Crystalline vinyl resin A22 | 35.0 |
| Example 43 | 43 | Suspension polymerization method | Crystalline vinyl resin A20 | 35.0 |
| Example 44 | 44 | Suspension polymerization method | Crystalline vinyl resin A3 | 35.0 |
| Example 45 | 45 | Suspension polymerization method | Crystalline vinyl resin A3 | 35.0 |
| Example 46 | 46 | Suspension polymerization method | Crystalline vinyl resin A3 | 35.0 |
| Example 47 | 47 | Suspension polymerization method | Crystalline vinyl resin A3 | 35.0 |
| Example 48 | 48 | Pulverization method | Crystalline vinyl resin A3 | 35.0 |
| Example 49 | 49 | Emulsion aggregation method | Crystalline vinyl resin A3 | 35.0 |
| Comparative | Comparison 1 | Suspension polymerization method | Crystalline vinyl resin A24 | 35.0 |
| example 1 | | | | |
| Comparative | Comparison 2 | Suspension polymerization method | Crystalline vinyl resin A25 | 35.0 |
| example 2 | | | | |
| Comparative | Comparison 3 | Suspension polymerization method | Crystalline vinyl resin A14 | 35.0 |
| example 3 | | | | |
| Comparative | Comparison 4 | Suspension polymerization method | None | — |
| example 4 | | | | |
| Comparative | Comparison 5 | Suspension polymerization method | Crystalline vinyl resin A3 | 35.0 |
| example 5 | | | | |
| Comparative | Comparison 6 | Suspension polymerization method | Crystalline vinyl resin A3 | 35.0 |
| example 6 | | | | |

TABLE 3-2

| | Binder resin | | | | | | | |
|---|---|---|---|---|---|---|---|---|
| | Amorphous vinyl resin B | | | | | | | |
| | Polymerizable | | Polymerizable | | Crosslinking | | | |
| | monomer b1 | | monomer b2 | | agent | | Release agent | |
| | | Amount | | Amount | | Amount | | Amount |
| Example | | added | | added | | added | | added |
| No. | Type | (parts) | Type | (parts) | Type | (parts) | Type | (parts) |
| Example 1 | St | 48.8 | BA | 16.2 | None | — | Release agent 1 | 9.0 |
| Example 2 | St | 7.5 | BA | 2.5 | None | — | Release agent 1 | 9.0 |
| Example 3 | St | 15.0 | BA | 5.0 | None | — | Release agent 1 | 9.0 |
| Example 4 | St | 33.8 | BA | 11.3 | None | — | Release agent 1 | 9.0 |
| Example 5 | St | 54.0 | BA | 18.0 | None | — | Release agent 1 | 9.0 |
| Example 6 | St | 59.3 | BA | 19.8 | None | — | Release agent 1 | 9.0 |
| Example 7 | St | 67.5 | BA | 22.5 | None | — | Release agent 1 | 9.0 |
| Example 8 | St | 48.8 | BA | 16.2 | None | — | Release agent 1 | 9.0 |
| Example 9 | St | 48.8 | BA | 16.2 | None | — | Release agent 1 | 9.0 |
| Example 10 | St | 48.8 | BA | 16.2 | None | — | Release agent 1 | 9.0 |
| Example 11 | St | 48.8 | BA | 16.2 | None | — | Release agent 1 | 9.0 |
| Example 12 | St | 48.8 | BA | 16.2 | None | — | Release agent 1 | 9.0 |
| Example 13 | St | 48.8 | BA | 16.2 | None | — | Release agent 1 | 9.0 |
| Example 14 | St | 48.8 | BA | 16.2 | None | — | Release agent 1 | 9.0 |
| Example 15 | St | 48.8 | BA | 16.2 | None | — | Release agent 1 | 9.0 |
| Example 16 | St | 48.8 | BA | 16.2 | None | — | Release agent 1 | 9.0 |
| Example 17 | St | 48.8 | BA | 16.2 | None | — | Release agent 1 | 9.0 |
| Example 18 | St | 48.8 | BA | 16.2 | None | — | Release agent 1 | 9.0 |
| Example 19 | St | 48.8 | BA | 16.2 | None | — | Release agent 1 | 9.0 |
| Example 20 | St | 48.8 | BA | 16.2 | None | — | Release agent 1 | 9.0 |
| Example 21 | St | 48.8 | BA | 16.2 | None | — | Release agent 1 | 9.0 |
| Example 22 | St | 48.8 | BA | 16.2 | None | — | Release agent 1 | 9.0 |
| Example 23 | St | 48.8 | BA | 16.2 | None | — | Release agent 1 | 9.0 |
| Example 24 | St | 48.8 | BA | 16.2 | None | — | Release agent 1 | 9.0 |
| Example 25 | St | 48.8 | BA | 16.2 | None | — | Release agent 1 | 9.0 |
| Example 26 | St | 48.8 | BA | 16.2 | None | — | Release agent 1 | 9.0 |
| Example 27 | St | 48.8 | BA | 16.2 | None | — | Release agent 1 | 9.0 |
| Example 28 | St | 48.8 | BA | 16.2 | None | — | Release agent 1 | 9.0 |
| Example 29 | St | 48.8 | BA | 16.2 | None | — | Release agent 2 | 9.0 |

TABLE 3-3

| | Binder resin | | | | | | | |
|---|---|---|---|---|---|---|---|---|
| | Amorphous vinyl resin B | | | | | | | |
| | Polymerizable | | Polymerizable | | Crosslinking | | | |
| | monomer b1 | | monomer b2 | | agent | | Release agent | |
| | | Amount | | Amount | | Amount | | Amount |
| Example | | added | | added | | added | | added |
| No. | Type | (parts) | Type | (parts) | Type | (parts) | Type | (parts) |
| Example 30 | St | 48.8 | BA | 16.2 | None | — | Release agent 3 | 9.0 |
| Example 31 | St | 48.8 | BA | 16.2 | None | — | Release agent 4 | 9.0 |
| Example 32 | St | 48.8 | BA | 16.2 | None | — | Release agent 5 | 9.0 |
| Example 33 | St | 48.8 | BA | 16.2 | None | — | Release agent 6 | 9.0 |
| Example 34 | St | 48.8 | BA | 16.2 | None | — | Release agent 7 | 9.0 |
| Example 35 | St | 48.8 | BA | 16.2 | None | — | Release agent 8 | 9.0 |
| Example 36 | St | 48.8 | BA | 16.2 | None | — | Release agent 9 | 9.0 |
| Example 37 | St | 48.8 | BA | 16.2 | None | — | Release agent 10 | 9.0 |
| Example 38 | St | 48.8 | BA | 16.2 | None | — | Release agent 1 | 0.5 |
| Example 39 | St | 48.8 | BA | 16.2 | None | — | Release agent 1 | 1.0 |
| Example 40 | St | 48.8 | BA | 16.2 | None | — | Release agent 1 | 27.0 |
| Example 41 | St | 48.8 | BA | 16.2 | None | — | Release agent 1 | 30.0 |
| Example 42 | St | 48.8 | BA | 16.2 | None | — | Release agent 4 | 9.0 |
| Example 43 | St | 48.8 | BA | 16.2 | None | — | Release agent 10 | 9.0 |
| Example 44 | St | 48.8 | BA | 16.2 | HDDA | 1.5 | Release agent 1 | 9.0 |
| Example 45 | St | 28.0 | BA | 37.1 | None | — | Release agent 1 | 9.0 |
| Example 46 | St | 63.1 | BA | 2.0 | None | — | Release agent 1 | 9.0 |
| Example 47 | St | 37.1 | BA | 28.0 | None | — | Release agent 1 | 9.0 |
| Example 48 | St | 48.8 | BA | 16.2 | None | — | Release agent 1 | 9.0 |
| Example 49 | St | 48.8 | BA | 16.2 | None | — | Release agent 1 | 9.0 |
| Comparative example 1 | St | 48.8 | BA | 16.2 | None | — | Release agent 1 | 9.0 |
| Comparative example 2 | St | 48.8 | BA | 16.2 | None | — | Release agent 1 | 9.0 |
| Comparative example 3 | St | 48.8 | BA | 16.2 | None | — | Release agent 1 | 9.0 |
| Comparative example 4 | — | — | — | — | None | — | Release agent 1 | 9.0 |
| Comparative example 5 | St | 48.8 | BA | 16.2 | None | — | Release agent 11 | 9.0 |
| Comparative example 6 | St | 48.8 | BA | 16.2 | None | — | Release agent 12 | 9.0 |

In the tables, HDDA stands for 1,6-hexanediol diacrylate, St stands for styrene, and BA stands for butyl acrylate.

TABLE 4

| | | | Molecular | Melting |
|---|---|---|---|---|
| | | | weight | point |
| | Name | Type | Mp | [° C.] |
| Release | Dipentaerythritol | Ester | 1900 | 80 |
| agent 1 | stearate ester wax | | | |
| Release | Carnauba wax | Ester | 820 | 83 |
| agent 2 | | | | |
| Release | Pentaerythritol | Ester | 1100 | 76 |
| agent 3 | palmitate ester wax | | | |
| Release | Dipentaerythritol | Ester | 1700 | 83 |
| agent 4 | palmitate ester wax | | | |
| Release | Excerex 30050B | Aliphatic | 2700 | 91 |
| agent 5 | | hydrocarbon | | |
| Release | Excerex 15341PA | Aliphatic | 1700 | 89 |
| agent 6 | | hydrocarbon | | |
| Release | Mitsui Hi-wax | Aliphatic | 2000 | 122 |
| agent 7 | 200P | hydrocarbon | | |
| Release | Excerex 48070B | Aliphatic | 4600 | 90 |
| agent 8 | | hydrocarbon | | |
| Release | Fischer-Tropsch | Aliphatic | 1100 | 105 |
| agent 9 | C105 | hydrocarbon | | |
| Release | Poly-α-olefin wax | Aliphatic | 1900 | 70 |
| agent 10 | | hydrocarbon | | |
| Release | Fischer-Tropsch | Aliphatic | 620 | 83 |
| agent 11 | C80 | hydrocarbon | | |
| Release | HNP10 | Aliphatic | 530 | 76 |
| agent 12 | | hydrocarbon | | |

In the table, release agents 3 and 4 are manufactured by Nisshin Oillio Co., Ltd., release agents 5 to 8 are manufactured by Mitsui Chemicals, Inc., release agents 9 and 11 are manufactured by Sasol Corp., and release agents 2 and 12 are manufactured by Nippon Seiro Co., Ltd. The molecular weight indicates the peak molecular weight.

TABLE 5-1

| | | | | | \|SPb − | |
|---|---|---|---|---|---|---|
| Example | Toner | Ratio J | Ratio K | Acid | SPa\| | Ratio H |
| No. | No. | (% by mass) | (% by mass) | value | (J/m³)^{0.5} | (% by mass) |
| Example 1 | 1 | 80.0 | 100.0 | 0.7 | 7.7 | 100.0 |
| Example 2 | 2 | 80.0 | 100.0 | 0.7 | 7.7 | 100.0 |
| Example 3 | 3 | 80.0 | 100.0 | 0.7 | 7.7 | 100.0 |
| Example 4 | 4 | 80.0 | 100.0 | 0.7 | 7.7 | 100.0 |
| Example 5 | 5 | 80.0 | 100.0 | 0.7 | 7.7 | 100.0 |
| Example 6 | 6 | 80.0 | 100.0 | 0.7 | 7.7 | 100.0 |
| Example 7 | 7 | 80.0 | 100.0 | 0.7 | 7.7 | 100.0 |
| Example 8 | 8 | 80.0 | 100.0 | 0.9 | 7.4 | 100.0 |
| Example 9 | 9 | 80.0 | 100.0 | 0.8 | 7.5 | 100.0 |
| Example 10 | 10 | 80.0 | 100.0 | 0.5 | 7.8 | 100.0 |
| Example 11 | 11 | 80.0 | 100.0 | 0.5 | 7.9 | 100.0 |
| Example 12 | 12 | 80.0 | 100.0 | 0.7 | 7.7 | 100.0 |
| Example 13 | 13 | 80.0 | 100.0 | 0.6 | 7.8 | 100.0 |
| Example 14 | 14 | 80.0 | 100.0 | 0.6 | 7.7 | 100.0 |
| Example 15 | 15 | 80.0 | 100.0 | 0.7 | 7.7 | 100.0 |
| Example 16 | 16 | 45.0 | 100.0 | 0.4 | 7.7 | 100.0 |
| Example 17 | 17 | 30.0 | 100.0 | 0.3 | 7.7 | 100.0 |
| Example 18 | 18 | 20.0 | 100.0 | 0.2 | 7.7 | 100.0 |
| Example 19 | 19 | 5.5 | 100.0 | 0.1 | 7.7 | 100.0 |
| Example 20 | 20 | 76.2 | 80.0 | 0.6 | 7.7 | 100.0 |
| Example 21 | 21 | 66.7 | 50.0 | 0.4 | 7.7 | 100.0 |
| Example 22 | 22 | 54.5 | 30.0 | 0.2 | 7.7 | 100.0 |
| Example 23 | 23 | 80.0 | 100.0 | 3.0 | 7.7 | 100.0 |
| Example 24 | 24 | 80.0 | 100.0 | 6.1 | 7.7 | 100.0 |
| Example 25 | 25 | 80.0 | 100.0 | 0.7 | 1.8 | 100.0 |
| Example 26 | 26 | 80.0 | 100.0 | 0.7 | 21.0 | 100.0 |
| Example 27 | 27 | 80.0 | 100.0 | 0.7 | 3.3 | 100.0 |
| Example 28 | 28 | 80.0 | 100.0 | 0.7 | 11.2 | 100.0 |
| Example 29 | 29 | 80.0 | 100.0 | 0.7 | 7.7 | 84.0 |
| Example 30 | 30 | 80.0 | 100.0 | 0.7 | 7.7 | 98.0 |
| Example 31 | 31 | 80.0 | 100.0 | 0.7 | 7.7 | 99.0 |
| Example 32 | 32 | 80.0 | 100.0 | 0.7 | 7.7 | 100.0 |
| Example 33 | 33 | 80.0 | 100.0 | 0.7 | 7.7 | 98.0 |
| Example 34 | 34 | 80.0 | 100.0 | 0.7 | 7.7 | 98.0 |
| Example 35 | 35 | 80.0 | 100.0 | 0.7 | 7.7 | 100.0 |
| Example 36 | 36 | 80.0 | 100.0 | 0.7 | 7.7 | 99.0 |
| Example 37 | 37 | 80.0 | 100.0 | 0.7 | 7.7 | 99.0 |
| Example 38 | 38 | 80.0 | 100.0 | 0.7 | 7.7 | 100.0 |
| Example 39 | 39 | 80.0 | 100.0 | 0.7 | 7.7 | 100.0 |
| Example 40 | 40 | 80.0 | 100.0 | 0.7 | 7.7 | 100.0 |
| Example 41 | 41 | 80.0 | 100.0 | 0.7 | 7.7 | 100.0 |
| Example 42 | 42 | 80.0 | 100.0 | 0.7 | 3.3 | 99.0 |
| Example 43 | 43 | 80.0 | 100.0 | 0.7 | 1.8 | 99.0 |
| Example 44 | 44 | 80.0 | 100.0 | 0.7 | 7.7 | 100.0 |
| Example 45 | 45 | 100.0 | 100.0 | 0.7 | 7.7 | 100.0 |
| Example 46 | 46 | 80.0 | 100.0 | 0.7 | 7.7 | 100.0 |
| Example 47 | 47 | 80.0 | 100.0 | 0.7 | 7.7 | 100.0 |
| Example 48 | 48 | 80.0 | 100.0 | 0.7 | 7.7 | 100.0 |
| Example 49 | 49 | 80.0 | 100.0 | 0.7 | 7.7 | 100.0 |
| Comparative example 1 | Comparison 1 | — | — | — | — | 100.0 |
| Comparative example 2 | Comparison 2 | — | — | — | — | 100.0 |
| Comparative example 3 | Comparison 3 | 4.0 | 100.0 | 0.7 | 7.7 | 100.0 |
| Comparative example 4 | Comparison 4 | — | — | — | — | 100.0 |
| Comparative example 5 | Comparison 5 | 80.0 | 100.0 | 0.7 | 7.7 | 22.0 |
| Comparative example 6 | Comparison 6 | 80.0 | 100.0 | 0.7 | 7.7 | 26.0 |

In the table, the ratio J indicates the content ratio (% by mass) of monomer unit (a) expressed by formula (1) based on the mass of the crystalline vinyl resin.

The ratio K indicates the content ratio (% by mass) of monomer unit (a) among monomer units having an alkyl group with 16 to 30 carbon atoms, including the monomer unit (a), in the crystalline vinyl resin.

The ratio H indicates the ratio of the area of the peak in the molecular weight region of 700 to 1,000,000 to the total area of the peaks in the molecular weight region of 1,000,000 or less in the molecular weight peaks of the release agent.

The unit of acid value is mg KOH/g.

TABLE 5-2

| Example | Ratio I | Ratio L | SP (A) − SP (W) | T1 | | tanδ(T1)/ |
|---|---|---|---|---|---|---|
| No. | (% by mass) | (% by mass) | (J/m³)^{0.5} | (° C.) | tanδ(T1) | tanδ(T1 − 10) |
| Example 1 | 35.0 | 25.7 | 1.0 | 59.3 | 0.53 | 1.42 |
| Example 2 | 90.0 | 10.0 | 1.0 | 55.3 | 0.94 | 1.74 |
| Example 3 | 80.0 | 11.3 | 1.0 | 57.3 | 0.82 | 1.63 |
| Example 4 | 55.0 | 16.4 | 1.0 | 58.5 | 0.65 | 1.55 |
| Example 5 | 28.0 | 32.1 | 1.0 | 60.7 | 0.48 | 1.40 |
| Example 6 | 21.0 | 42.9 | 1.0 | 61.6 | 0.41 | 1.33 |
| Example 7 | 10.0 | 90.0 | 1.0 | 62.3 | 0.32 | 1.27 |
| Example 8 | 35.0 | 25.7 | 1.3 | 51.7 | 0.53 | 1.42 |
| Example 9 | 35.0 | 25.7 | 1.2 | 55.0 | 0.52 | 1.42 |
| Example 10 | 35.0 | 25.7 | 0.9 | 63.8 | 0.53 | 1.41 |
| Example 11 | 35.0 | 25.7 | 0.9 | 69.1 | 0.53 | 1.42 |
| Example 12 | 35.0 | 25.7 | 1.0 | 59.8 | 0.52 | 1.41 |
| Example 13 | 35.0 | 25.7 | 1.0 | 59.8 | 0.53 | 1.42 |
| Example 14 | 35.0 | 25.7 | 1.0 | 59.2 | 0.53 | 1.43 |
| Example 15 | 35.0 | 25.7 | 1.0 | 59.1 | 0.52 | 1.41 |
| Example 16 | 35.0 | 25.7 | 1.7 | 60.0 | 0.42 | 1.35 |
| Example 17 | 35.0 | 25.7 | 2.0 | 61.1 | 0.40 | 1.28 |
| Example 18 | 35.0 | 25.7 | 2.2 | 62.2 | 0.38 | 1.40 |
| Example 19 | 35.0 | 25.7 | 2.2 | 65.2 | 0.31 | 1.22 |
| Example 20 | 35.0 | 25.7 | 1.0 | 59.8 | 0.53 | 1.42 |
| Example 21 | 35.0 | 25.7 | 1.0 | 59.1 | 0.53 | 1.43 |
| Example 22 | 35.0 | 25.7 | 1.0 | 59.4 | 0.52 | 1.42 |
| Example 23 | 35.0 | 25.7 | 1.0 | 59.7 | 0.54 | 1.41 |
| Example 24 | 35.0 | 25.7 | 1.0 | 59.6 | 0.53 | 1.42 |
| Example 25 | 35.0 | 25.7 | 0.3 | 59.2 | 0.53 | 1.43 |
| Example 26 | 35.0 | 25.7 | 2.1 | 59.1 | 0.52 | 1.41 |
| Example 27 | 35.0 | 25.7 | 0.4 | 59.3 | 0.53 | 1.42 |
| Example 28 | 35.0 | 25.7 | 1.5 | 59.5 | 0.54 | 1.42 |
| Example 29 | 35.0 | 25.7 | 1.8 | 59.9 | 0.53 | 1.41 |
| Example 30 | 35.0 | 25.7 | 1.0 | 59.4 | 0.52 | 1.42 |
| Example 31 | 35.0 | 25.7 | 0.9 | 59.7 | 0.53 | 1.42 |
| Example 32 | 35.0 | 25.7 | 1.9 | 59.2 | 0.53 | 1.43 |
| Example 33 | 35.0 | 25.7 | 1.9 | 59.3 | 0.53 | 1.43 |
| Example 34 | 35.0 | 25.7 | 2.0 | 59.8 | 0.53 | 1.42 |
| Example 35 | 35.0 | 25.7 | 1.9 | 59.0 | 0.53 | 1.41 |
| Example 36 | 35.0 | 25.7 | 2.0 | 59.3 | 0.52 | 1.43 |
| Example 37 | 35.0 | 25.7 | 2.0 | 59.0 | 0.53 | 1.42 |
| Example 38 | 35.0 | 1.4 | 1.0 | 59.8 | 0.54 | 1.41 |
| Example 39 | 35.0 | 2.9 | 1.0 | 59.7 | 0.53 | 1.43 |
| Example 40 | 35.0 | 77.1 | 1.0 | 59.5 | 0.53 | 1.42 |
| Example 41 | 35.0 | 85.7 | 1.0 | 59.2 | 0.54 | 1.43 |
| Example 42 | 35.0 | 25.7 | 0.3 | 59.4 | 0.53 | 1.41 |
| Example 43 | 35.0 | 25.7 | 1.2 | 59.2 | 0.53 | 1.42 |
| Example 44 | 34.5 | 25.7 | 1.0 | 59.6 | 0.25 | 1.25 |
| Example 45 | 35.0 | 25.7 | 1.0 | 59.1 | 1.10 | 1.71 |
| Example 46 | 35.0 | 25.7 | 1.0 | 59.6 | 0.53 | 0.92 |
| Example 47 | 35.0 | 25.7 | 1.0 | 59.4 | 0.54 | 1.95 |
| Example 48 | 35.0 | 25.7 | 2.0 | 59.0 | 0.53 | 1.43 |
| Example 49 | 35.0 | 25.7 | 1.0 | 59.0 | 0.53 | 1.41 |
| Comparative example 1 | — | — | — | 63.1 | 0.53 | 1.43 |
| Comparative example 2 | — | — | — | 60.2 | 0.54 | 1.42 |
| Comparative example 3 | 35.0 | 25.7 | 1.0 | 69.3 | 0.20 | 1.14 |
| Comparative example 4 | — | — | — | 57.5 | 0.86 | 1.58 |
| Comparative example 5 | 35.0 | 25.7 | 2.0 | 59.0 | 0.54 | 1.42 |
| Comparative example 6 | 35.0 | 25.7 | 2.0 | 59.9 | 0.53 | 1.43 |

In the table, the ratio I indicates the content ratio (% by mass) of crystalline vinyl resin based on the mass of binder resin.

The ratio L indicates the content ratio (% by mass) of release agent based on the mass of crystalline vinyl resin.

### Example 48

### Preparation of Toner by Pulverization Method

Crystalline vinyl resin (A3) 35.0 parts by mass
Amorphous resin B1 65.0 parts by mass
C. I. Pigment Blue 15:3 6.5 parts by mass
Release agent 1 9.0 parts by mass

The above materials were premixed in an FM mixer (manufactured by Nippon Coke and Engineering Co., Ltd.), and then melt-kneaded using a twin-screw kneading extruder (PCM-30 model, manufactured by Ikegai Iron Works Co., Ltd.).

The resulting kneaded product was cooled and coarsely pulverized in a hammer mill, then pulverized in a mechanical pulverizer (T-250, manufactured by Turbo Kogyo Co., Ltd.). The resulting finely pulverized powder was classified using a multi-division classifier utilizing the Coanda effect to obtain toner particles 48.

Furthermore, the external addition to toner particles 48 was performed in the same manner as in Example 1 to obtain toner 48. The resulting toner 48 was evaluated by the methods shown hereinbelow. The physical properties of toner 48 are shown in Tables 5-1 and 5-2, and the evaluation results are shown in Table 6-2.

### Example 49

### Production of Toner by Emulsion Aggregation Method

### Preparation of Crystalline Resin Dispersion Liquid

Toluene 300.0 parts by mass
Crystalline vinyl resin (A3) 100.0 parts by mass

The above materials were weighed, mixed, and dissolved at 90° C. to obtain a toluene solution.

Separately, 5.0 parts by mass of sodium dodecylbenzenesulfonate and 10.0 parts by mass of sodium laurate were added to 700.0 parts by mass of ion-exchanged water and dissolved by heating at 90° C. to obtain an aqueous solution. The toluene solution and the aqueous solution were then mixed and stirred at 7000 rpm using an ultra-high speed stirring device T. K. Robomix (manufactured by Primix Corporation). The mixture was then emulsified at a pressure of 200 MPa using a high-pressure impact disperser Nanomizer (manufactured by Yoshida Kikai Co., Ltd.). After that, the toluene was removed using an evaporator, and the concentration was adjusted with ion-exchanged water to obtain a crystalline resin dispersion liquid with a concentration of crystalline resin A3 fine particles of 20% by mass.

The 50% particle diameter (D50) based on volume distribution of the crystalline resin A3 fine particles was measured using a dynamic light scattering particle diameter distribution meter Nanotrac UPA-EX150 (manufactured by Nikkiso Co., Ltd.), and was found to be 0.41 m.

### Preparation of Amorphous Resin Dispersion Liquid

Toluene 300.0 parts by mass
Amorphous resin B1 100.0 parts by mass

The above materials were weighed, mixed, and dissolved at 90° C. to obtain a toluene solution.

Separately, 5.0 parts by mass of sodium dodecylbenzenesulfonate and 10.0 parts by mass of sodium laurate were added to 700.0 parts by mass of ion-exchanged water and dissolved by heating at 90° C. to obtain an aqueous solution. The above toluene solution and aqueous solution were then mixed and stirred at 7000 rpm using the ultra-high speed stirring device T. K. Robomix (manufactured by Primix Corporation). The mixture was then emulsified at a pressure of 200 MPa using the high-pressure impact disperser Nanomizer (manufactured by Yoshida Kikai Co., Ltd.). After that, the toluene was removed using an evaporator, and the concentration was adjusted with ion-exchanged water to obtain an amorphous resin dispersion liquid with a concentration of amorphous resin fine particles of 20% by mass.

The 50% particle diameter (D50) based on volume distribution of the amorphous resin fine particles was measured using a dynamic light scattering particle diameter distribution meter Nanotrac UPA-EX150 (manufactured by Nikkiso Co., Ltd.), and was found to be 0.39 μm.

### Preparation of Release Agent Dispersion Liquid

Release agent 1 100.0 parts by mass
Anionic surfactant Neogen RK (manufactured by DKS Co., Ltd.) 5.0 parts by mass
Ion-exchanged water 395.0 parts by mass

The above materials were weighed and placed in a mixing vessel equipped with a stirrer, then heated to 90° C. and circulated through a Clearmix W Motion (manufactured by M Technique Co., Ltd.) for 60 min for dispersion processing. The dispersion processing conditions were as follows:
Rotor outer diameter: 3 cm
Clearance: 0.3 mm
Rotor rotation speed: 19,000 r/min
Screen rotation speed: 19,000 r/min

After dispersion processing, the dispersion liquid was cooled to 40° C. at a rotor rotation speed of 1000 r/min, a screen rotation speed of 0 r/min, and a cooling rate of 10° C./min as cooling conditions, to obtain a release agent dispersion liquid with a release agent fine particle concentration of 20% by mass.

The 50% particle diameter (D50) based on the volume distribution of the release agent fine particles was measured using the dynamic light scattering particle diameter distribution meter Nanotrac UPA-EX150 (manufactured by Nikkiso Co., Ltd.) and found to be 0.14 m.

### Preparation of Colorant Dispersion Liquid

C. I. Pigment Blue 15:3 50.0 parts by mass
Anionic surfactant Neogen RK (manufactured by DKS Co., Ltd.) 7.5 parts by mass
Ion-exchanged water 442.5 parts by mass

The above materials were weighed, mixed, dissolved, and dispersed for 1 h using the high-pressure impact disperser Nanomizer (manufactured by Yoshida Kikai Co., Ltd.), to obtain a colorant dispersion liquid with a concentration of 10% by mass of colorant fine particles.

The 50% particle diameter (D50) based on the volume distribution of the fine particles of release agent was measured using the dynamic light scattering particle diameter distribution meter Nanotrac UPA-EX150 (manufactured by Nikkiso Co., Ltd.) and found to be 0.20 m.

### Production of Toner 49

Crystalline resin dispersion liquid 200.0 parts by mass
Amorphous resin dispersion liquid 300.0 parts by mass
Release agent dispersion liquid 45.0 parts by mass
Colorant dispersion liquid 65.0 parts by mass
Ion-exchanged water 160.0 parts by mass

The above materials were placed in a round stainless steel flask and mixed. Then, a homogenizer Ultra Turrax T50 (manufactured by IKA Works, Inc.) was used to disperse the mixture at 5000 rpm for 10 min. After adding a 1.0% aqueous nitric acid solution and adjusting the pH to 3.0, the mixture was heated to 58° C. in a heated water bath while appropriately adjusting the rotation speed so that the mixture was stirred using a stirring blade. The volume-average particle diameter of the formed aggregated particles was confirmed, as appropriate, using a Coulter Multisizer III, and when aggregated particles with a weight-average particle diameter (D4) of 6.83 μm were formed, the pH was adjusted to 9.0 using a 5% aqueous sodium hydroxide solution. After that, the mixture was heated to 75° C. while continuing to stir. The aggregated particles were fused by holding at 75° C. for 1 h.

Then, the mixture was cooled to 45° C. and heat-treated for 5 h.

Then, the mixture was cooled to 25° C., filtered and solid-liquid separated, and washed with ion-exchanged water. The washing was followed by drying using a vacuum dryer to obtain toner particles 49.

External addition to toner particles 49 was performed in the same manner as in Example 1 to obtain toner 49. The obtained toner 49 was evaluated by the methods shown hereinbelow. The physical properties of toner 49 are shown in Tables 5-1 and 5-2, and the evaluation results are shown in Table 6-2.

### Comparative Examples 1 to 3, 5 and 6

Comparative toner particles 1 to 3, 5 and 6 were obtained in the same manner as in Example 1, except that the types and amounts added of crystalline vinyl resin, polymerizable monomers, release agent, and crosslinking agent used were changed as shown in Tables 3-1 and 3-3. Furthermore, the external addition was performed in the same manner as in Example 1 to obtain comparative toners 1 to 3, 5 and 6. The obtained comparative toners 1 to 3, 5 and 6 were evaluated by the methods shown below. The physical properties of the toners are shown in Tables 5-1 and 5-2, and the evaluation results are shown in Table 6-2.

### Comparative Example 4

### Production of Comparative Toner Particles 4

Monomer composition 100.0 parts by mass
   (The monomer composition is a mixture of behenyl acrylate, methacrylonitrile, and styrene in the ratios shown below)
(Behenyl acrylate (first polymerizable monomer): 67.0 parts by mass (28.9 mol %))
(Methacrylonitrile (second polymerizable monomer): 22.0 parts by mass (53.9 mol %))
(Styrene (third polymerizable monomer): 11.0 parts by mass (17.2 mol %))
Pigment Blue 15:3 6.5 parts by mass
Di-t-butyl aluminum salicylate 1.0 parts by mass
Release agent 1 9.0 parts by mass
   (Dipentaerythritol stearate ester wax, manufactured by Nisshin Oillio Co., Ltd.)
Toluene 100.0 parts by mass

A mixture of the above materials was prepared. The mixture was placed in an attritor (manufactured by Nippon Coke Co., Ltd.) and dispersed for 2 h at 200 rpm using zirconia beads with a diameter of 5 mm to obtain a raw material dispersion liquid.

Meanwhile, 735.0 parts by mass of ion-exchanged water and 16.0 parts by mass of trisodium phosphate (12-hydrate) were added to a container equipped with a high-speed stirring device Homomixer (manufactured by Primix Corporation) and a thermometer, and the temperature was raised to 60° C. while stirring at 12,000 rpm. An aqueous calcium chloride solution prepared by dissolving 9.0 parts by mass of calcium chloride (dihydrate) in 65.0 parts by mass of ion-exchanged water was added thereto, and stirring was carried out at 12,000 rpm for 30 min while keeping the temperature at 60° C. Then, 10% hydrochloric acid was added thereto to adjust the pH to 6.0, yielding an aqueous medium in which an inorganic dispersion stabilizer containing hydroxyapatite was dispersed in water.

The raw material dispersion liquid was then transferred to a container equipped with a stirrer and a thermometer, and the temperature was raised to 60° C. while stirring at 100 rpm. A total of 8.0 parts by mass of t-butyl peroxypivalate (Perbutyl PV, manufactured by NOF Corp.) was added as a polymerization initiator and then stirring was performed for 5 min at 100 rpm while keeping the temperature at 60° C. The mixture was then charged into the aqueous medium being stirred at 12,000 rpm with the high-speed stirring device. The stirring was continued for 20 min at 12,000 rpm with the high-speed stirring device while keeping the temperature at 60° C., and a granulation liquid was obtained.

The granulation liquid was transferred to a reaction vessel equipped with a reflux condenser, a stirrer, a thermometer, and a nitrogen introduction tube, and the temperature was raised to 70° C. while stirring at 150 rpm under a nitrogen atmosphere. The polymerization reaction was carried out at 150 rpm for 10 h while keeping the temperature at 70° C. After that, the reflux condenser was removed from the reaction vessel, and the temperature of the reaction liquid was raised to 95° C. The toluene was then removed by stirring at 150 rpm for 5 h while keeping the temperature at 95° C., and a toner particle dispersion liquid was obtained.

The obtained toner particle dispersion liquid was cooled to 20° C. while stirring at 150 rpm, and dilute hydrochloric acid was added, while stirring, until the pH reached 1.5 to dissolve the dispersion stabilizer. The solid fraction was filtered off and thoroughly washed with ion-exchanged water, and then vacuum-dried at 40° C. for 24 hours to obtain comparative toner particles 4. Furthermore, the external addition was performed in the same manner as in Example 1 to obtain comparative toner 4. The obtained comparative toner 4 was evaluated by the methods shown hereinbelow. The physical properties of the toner are shown in Tables 5-1 and 5-2, and the evaluation results are shown in Table 6-2.

TABLE 6-1

| | | | | Speed at | | |
|---|---|---|---|---|---|---|
| | | Low- | Hot offset | which fixing | | |
| | | temperature | resistance | is possible | Gloss | Gloss |
| | | fixability | Range in | Speed at | Average | unevenness |
| | | Fixing start | which fixing | which fixing | value of | Standard |
| Example | Toner | temperature | is possible | is possible | gloss | deviation |
| No. | No. | (° C.) | (° C.) | (mm/sec) | (%) | of gloss |
| Example 1 | 1 | 100 | 65 | 400 | 25.1 | 0.56 |
| Example 2 | 2 | 90 | 60 | 400 | 28.1 | 1.67 |
| Example 3 | 3 | 90 | 60 | 400 | 27.5 | 1.21 |
| Example 4 | 4 | 95 | 65 | 400 | 26.0 | 0.89 |
| Example 5 | 5 | 105 | 65 | 400 | 25.0 | 0.75 |
| Example 6 | 6 | 110 | 70 | 400 | 24.1 | 0.61 |
| Example 7 | 7 | 120 | 70 | 400 | 21.5 | 0.48 |
| Example 8 | 8 | 90 | 60 | 400 | 25.0 | 0.56 |
| Example 9 | 9 | 95 | 60 | 400 | 25.1 | 0.57 |
| Example 10 | 10 | 110 | 65 | 400 | 25.2 | 0.57 |
| Example 11 | 11 | 120 | 70 | 400 | 25.0 | 0.56 |
| Example 12 | 12 | 100 | 65 | 360 | 25.1 | 0.56 |
| Example 13 | 13 | 100 | 65 | 390 | 25.2 | 0.56 |
| Example 14 | 14 | 100 | 65 | 400 | 25.1 | 0.57 |
| Example 15 | 15 | 100 | 70 | 400 | 25.2 | 0.56 |
| Example 16 | 16 | 110 | 65 | 400 | 24.7 | 0.56 |
| Example 17 | 17 | 115 | 70 | 390 | 24.1 | 0.54 |
| Example 18 | 18 | 115 | 70 | 350 | 22.9 | 0.56 |
| Example 19 | 19 | 120 | 70 | 330 | 20.8 | 0.48 |
| Example 20 | 20 | 100 | 65 | 390 | 25.1 | 0.56 |
| Example 21 | 21 | 100 | 65 | 350 | 25.1 | 0.57 |
| Example 22 | 22 | 100 | 65 | 330 | 25.2 | 0.55 |
| Example 23 | 23 | 105 | 65 | 400 | 25.1 | 0.56 |
| Example 24 | 24 | 110 | 65 | 400 | 25.2 | 0.57 |
| Example 25 | 25 | 115 | 45 | 400 | 25.2 | 0.55 |
| Example 26 | 26 | 100 | 65 | 400 | 25.2 | 0.56 |
| Example 27 | 27 | 105 | 55 | 400 | 25.1 | 0.56 |
| Example 28 | 28 | 100 | 65 | 400 | 25.2 | 0.56 |
| Example 29 | 29 | 100 | 40 | 370 | 25.1 | 0.57 |

TABLE 6-2

| | | | | Speed at | | |
|---|---|---|---|---|---|---|
| | | Low- | Hot offset | which fixing | | |
| | | temperature | resistance | is possible | Gloss | Gloss |
| | | fixability | Range in | Speed at | Average | unevenness |
| | | Fixing start | which fixing | which fixing | value of | Standard |
| Example | Toner | temperature | is possible | is possible | gloss | deviation of |
| No. | No. | (° C.) | (° C.) | (mm/sec) | (%) | gloss |
| Example 30 | 30 | 100 | 55 | 390 | 25.0 | 0.55 |
| Example 31 | 31 | 100 | 60 | 390 | 25.2 | 0.56 |
| Example 32 | 32 | 105 | 65 | 360 | 25.1 | 0.56 |
| Example 33 | 33 | 100 | 65 | 360 | 25.0 | 0.56 |
| Example 34 | 34 | 120 | 45 | 350 | 25.2 | 0.55 |
| Example 35 | 35 | 105 | 55 | 360 | 25.1 | 0.56 |
| Example 36 | 36 | 105 | 70 | 390 | 25.2 | 0.56 |
| Example 37 | 37 | 95 | 70 | 410 | 25.2 | 0.57 |
| Example 38 | 38 | 105 | 45 | 400 | 25.2 | 0.55 |
| Example 39 | 39 | 100 | 50 | 400 | 25.1 | 0.56 |
| Example 40 | 40 | 100 | 65 | 400 | 25.1 | 0.55 |
| Example 41 | 41 | 100 | 65 | 400 | 25.1 | 0.56 |
| Example 42 | 42 | 100 | 40 | 400 | 25.1 | 0.56 |
| Example 43 | 43 | 110 | 60 | 400 | 25.0 | 0.55 |
| Example 44 | 44 | 105 | 65 | 400 | 15.3 | 0.56 |
| Example 45 | 45 | 90 | 40 | 400 | 28.8 | 1.34 |
| Example 46 | 46 | 115 | 70 | 400 | 25.1 | 0.40 |
| Example 47 | 47 | 95 | 70 | 400 | 25.0 | 2.77 |
| Example 48 | 48 | 105 | 70 | 390 | 25.1 | 0.56 |
| Example 49 | 49 | 100 | 65 | 400 | 25.2 | 0.56 |
| Comparative example 1 | Comparison 1 | 105 | 50 | 260 | 25.1 | 0.55 |
| Comparative example 2 | Comparison 2 | 95 | 65 | 290 | 25.0 | 0.56 |
| Comparative example 3 | Comparison 3 | 125 | 65 | 330 | 19.1 | 0.46 |
| Comparative example 4 | Comparison 4 | 100 | 65 | 280 | 26.9 | 1.12 |
| Comparative example 5 | Comparison 5 | 100 | 30 | 330 | 25.0 | 0.56 |
| Comparative example 6 | Comparison 6 | 100 | 35 | 340 | 25.1 | 0.55 |

### Toner Evaluation Methods

The following evaluations were carried out for each of the obtained toners.

### <1> Low-Temperature Fixability

A process cartridge filled with the toner was stored for 48 h at a temperature of 25° C. and a relative humidity of 40%. An LBP-712Ci (manufactured by Canon Inc.) modified to enable operation even when the fixing unit was removed was used, and an unfixed image of an image pattern in which 30 mm×30 mm square images were evenly arranged in 9 points over the entire transfer paper was output. The toner laid-on level on the transfer paper was 0.80 mg/cm², and the fixing start temperature was evaluated. The transfer paper used was A4 paper with a rough texture (“Prover Bond Paper”: 105 g/m², manufactured by Fox River Co.).

The fixing unit used was an external fixing unit that had been removed from the LBP-712Ci and modified to be capable to operate even outside the laser beam printer. The fixing temperature of the external fixing unit was raised in 5° C. increments from 90° C., and fixing was performed under the condition of a process speed of 400 mm/sec.

The fixed image was visually checked, and the minimum temperature at which cold offset did not occur was evaluated as the fixing start temperature. The evaluation results are shown in Tables 6-1 and 6-2.

### <2> Hot Offset Resistance

The highest temperature at which no hot offset was observed under the same conditions as for low-temperature fixability was defined as the maximum fixing temperature, and the difference between the maximum and minimum fixing temperatures was evaluated as the range in which fixing is possible. The evaluation results are shown in Tables 6-1 and 6-2.

<3> Speed at which Fixing is Possible after Storage in High-Temperature Environment

The process cartridge used for evaluating the low-temperature fixability was allowed to stand for 3 days in an environment with a temperature of 50° C. and a relative humidity of 40 RH %, and then allowed to stand for 48 h at 25° C. and a relative humidity of 40%.

After that, an unfixed image was output under the same conditions as for the evaluation of <1> Low-Temperature Fixability, and the same external fixing unit was used. Fixing evaluation was performed by setting the temperature to the lowest temperature at which cold offset did not occur in the evaluation of <1> Low-Temperature Fixability and lowering the process speed in increments of 10 mm/sec from 400 mm/sec. The fixed image was visually checked to evaluate the process speed at which offset did not occur. The highest process speed among the speeds at which offset did not occur was determined to be the speed at which fixing is possible. The evaluation results are shown in Tables 6-1 and 6-2.

### <4> Evaluation of Gloss and Gloss Unevenness

The fixed image at the fixing start temperature output in the evaluation of <1> above was used. The gloss value was measured using a handy gloss meter PG-1 (manufactured by Nippon Denshoku Industries Co., Ltd.). The measurement conditions were set to 750 for the projection angle and reception angle, and all image patterns arranged at 9 points were measured. The average gloss value and standard deviation of gloss were evaluated as gloss unevenness (gloss uniformity). The evaluation results are shown in Tables 6-1 and 6-2.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-210474, filed Dec. 13, 2023 and Japanese Patent Application No. 2024-204562, filed Nov. 25, 2024 which are hereby incorporated by reference herein in their entirety.

What is claimed is:

1. A toner comprising a toner particle comprising a binder resin and a release agent, wherein
the binder resin comprises a crystalline vinyl resin,
the crystalline vinyl resin comprises 5.0% by mass or more of a monomer unit (a) represented by a following formula (1), based on a mass of the crystalline vinyl resin, 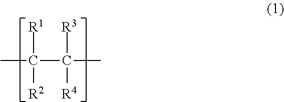
in the formula (1), at least two of R¹ to R⁴ are each independently —X—COOR⁵, and a remaining is each independently a hydrogen atom or an alkyl group having 1 to 4 carbon atoms, X is a single bond or an alkylene group having 1 or 2 carbon atoms, R⁵ is an alkyl group having 16 to 30 carbon atoms, and
a peak molecular weight Mp of the release agent is 800 or more.

2. The toner according to claim 1, wherein in a molecular weight distribution of o-dichlorobenzene soluble matter of the release agent measured by gel permeation chromatography,
in a differential molecular weight distribution curve obtained by RI detection in which a horizontal axis represents log M, which is a logarithm of a molecular weight, and a vertical axis represents a value [dW/d(log M)] obtained by differentiating a concentration fraction by the logarithm of the molecular weight,
a ratio of an area of a peak in a region of molecular weights of 700 to 1,000,000 to a total area of peaks in a region of molecular weights of 1,000,000 or less is 90.0% or more.

3. The toner according to claim 1, wherein the binder resin comprises 20.0% by mass to 100.0% by mass of the crystalline vinyl resin, based on a mass of the binder resin.

4. The toner according to claim 1, wherein the crystalline vinyl resin comprises 30.0% by mass or more of the monomer unit (a), based on the mass of the crystalline vinyl resin.

5. The toner according to claim 1, wherein a content ratio of the monomer unit (a) among monomer units which have an alkyl group having 16 to 30 carbon atoms, and include the monomer unit (a), in the crystalline vinyl resin is 50.0% by mass to 100.0% by mass.

6. The toner according to claim 1, wherein an acid value of the crystalline vinyl resin is 3.0 mg KOH/g or less.

7. The toner according to claim 1, wherein a content ratio of the release agent is 2.0% by mass to 80.0% by mass, based on the mass of the crystalline vinyl resin.

8. The toner according to claim 1, wherein the peak molecular weight Mp of the release agent is 1000 to 5000.

9. The toner according to claim 1, wherein a melting point of the release agent is 60 to 120° C.

10. The toner according to claim 1, wherein, where an SP value of the crystalline vinyl resin is SP(A) (J/cm³)^{0.5} and an SP value of the release agent is SP(W) (J/cm³)^{0.5}, the SP(A) and the SP(W) satisfy a following formula (2):
$$( SP ( A ) - SP ( W ) ) \geq 0.4 . \qquad ( 2 )$$

11. The toner according to claim 1, wherein
the crystalline vinyl resin comprises, in addition to the monomer unit (a), a monomer unit (b) different from the monomer unit (a), and
where an SP value of the monomer unit (a) is SPa (J/cm³)^{0.5} and an SP value of the monomer unit (b) is SPb (J/cm³)^{0.5}, the SPa and the SPb satisfy a following formula (3):
$$3. \leq \vert SPb - SPa \vert \leq 21. . \qquad ( 3 )$$

12. The toner according to claim 1, wherein the release agent comprises an ester wax.

13. The toner according to claim 12, wherein the release agent comprises an ester wax being an ester of a tetrahydric to octahydric alcohol and an aliphatic monocarboxylic acid, or an ester wax being an ester of a tetravalent to octavalent carboxylic acid and an aliphatic monoalcohol.

14. The toner according to claim 1, wherein the release agent comprises an aliphatic hydrocarbon wax.

15. The toner according to claim 14, wherein the release agent comprises a poly-α-olefin wax.

16. The toner according to claim 1, wherein where a temperature at which a storage elastic modulus G^{′} of the toner in viscoelasticity measurement of the toner is 1.0×10⁷ Pa is T1 (° C.), the T1 satisfies a following formula (4):
$$50. \leq T 1 \leq 70.0 \qquad ( 4 )$$
and
where a ratio of a loss elastic modulus G″ to the storage elastic modulus G^{′} of the toner at the T1 (° C.) in the viscoelasticity measurement of the toner is tan δ (T1), and a ratio of a loss elastic modulus G″ to a storage elastic modulus G^{′} of the toner at a temperature of T1−10 (° C.) is tan δ (T1−10), the tan δ (T1) and the tan δ (T1−10) satisfy following formulas (5) and (6):
$$0.3 \leq tan δ ( T 1 ) \leq 1. \qquad ( 5 )$$
$$1. \leq tan δ ( T 1 ) / tan δ ( T 1 - 10 ) \leq 1.9 . \qquad ( 6 )$$
